(19) United States
(12) Patent Application Publication
(10) Pub. No.: US 2023/0306127 A1
(43) Pub. Date: Sep. 28, 2023

(54) SYSTEM AND METHOD FOR A MACHINE-LEARNING ADAPTIVE PERMISSION REDUCTION ENGINE

(71) Applicant: ORCA SECURITY LTD., Tel Aviv-Yafo (IL)

(72) Inventors: Avi SHUA, Ramat Gan (IL); Itamar GOLAN, Tel Aviv (IL); Lior DRIHEM, Givat Shmuel (IL)

(73) Assignee: ORCA SECURITY LTD., Tel Aviv-Yafo (IL)

(21) Appl. No.: 18/189,744

(22) Filed: Mar. 24, 2023

Related U.S. Application Data
(63) Continuation of application No. PCT/IB2023/052274, filed on Mar. 9, 2023.
(60) Provisional application No. 63/269,138, filed on Mar. 10, 2022.

(51) Int. Cl. G06F 21/62; G06F 21/60

(52) U.S. Cl. CPC G06F 21/6218; G06F 21/604; G06F 2221/2113

(57) ABSTRACT

This disclosure describes many innovations including but not limited to systems, methods, and non-transitory computer readable media containing instructions for managing permission policies. Managing policies includes collecting activities for a plurality of identities, where each identity has a permission policy, and each activity complies with the permission policy; for each identity, calculating a risk margin indicating a gap between the permission policy and the activities; determining a plurality of clustering schemes, each corresponding to a partition of the identities based on a similarity of the activities; for at least one cluster of at least one clustering schemes, determining a reduced permission policy excluding a permission, while allowing each identity in the cluster to subsequently perform each activity; calculating an average risk margin for each clustering scheme based on the reduced permission policy; and select a specific clustering scheme based on a number of clusters and the average risk margin.

### CROSS REFERENCES TO RELATED APPLICATIONS

This application claims the benefit of priority of U.S. Provisional Pat. Application No. 63/269,138, filed on Mar. 10, 2022, which is incorporated herein by reference in its entirety.

### BACKGROUND

### I. Technical Field

The present disclosure generally relates to the field of cloud computing. More specifically, the present disclosure relates to systems, methods, and devices for managing permissions in a cloud computing environment.

### II. Background Information

Cloud platforms may manage access to resources using permission policies. However, permission polices may introduce discrepancies between granted permissions versus used or needed permissions. Such discrepancies may be particularly pertinent in large organizations having many users with diverse needs. An under-provisioned policy may lack permissions needed to access resources required to effectively fulfill responsibilities. Under-provisioned policies may lead to frustration, inefficiencies, and technical failures. An over-provisioned policy may grant broader permissions that what may be required to fulfill routine responsibilities. Over-provisioned policies may unnecessarily grant access to sensitive resources, thereby introducing risks that may lead to corruption or harm.

Some cloud platforms may provide default permission policies, which may be static, broad and generic by nature. While simple to apply, default permission policies may suffer from over-provisioning or under-provisioning. Customized or personalized permission policies may alleviate over-provisioning or under-provisioning. However developing a custom permission policy for each user in a large organization may be inefficient and difficult to maintain.

### SUMMARY

Embodiments consistent with the present disclosure provide systems and methods generally relating to managing a plurality of permission policies. The disclosed systems and methods may be implemented using a combination of conventional hardware and software as well as specialized hardware and software, such as a machine constructed and/or programmed specifically for performing functions associated with the disclosed method steps. Consistent with other disclosed embodiments, non-transitory computer readable storage media may store program instructions, which are executable by at least one processing device and perform any of the steps and/or methods described herein.

Consistent with disclosed embodiments, systems, methods, and computer readable media for collecting a plurality of activities associated with each of a plurality of identities, wherein each identity of the plurality of identities corresponds to a permission policy, and wherein each activity of the plurality of activities complies with the permission policy corresponding to the associated identity; for each identity, calculating a risk margin indicating a gap between the corresponding permission policy and the associated activities; determining a plurality of candidate clustering schemes for the plurality of identities, wherein each candidate clustering scheme includes a plurality of distinct non-overlapping clusters corresponding to a partition of the plurality of identities based on a similarity measure of the associated activities; for at least one distinct non-overlapping cluster of at least one of the plurality of candidate clustering schemes, determining a reduced permission policy, the reduced permission policy excluding at least one permission included in the permission policy for at least one identity included in the cluster, while allowing each identity in the cluster to subsequently perform each associated activity; calculating an average risk margin for each candidate clustering scheme based on the at least one reduced permission policy for the at least one cluster; and selecting a specific clustering scheme from the plurality of candidate clustering schemes based on a number of clusters for each candidate clustering scheme and the average risk margin for each candidate clustering scheme.

Consistent with disclosed embodiments, systems, methods, and computer readable media for determining utilized permissions in a cloud computing environment; receiving authorizations granted to each identity of a plurality of identities associated with the cloud computing environment; collecting a plurality of audit logs of activities performed in the cloud computing environment, the plurality of audit logs including at least: a plurality of cloud services accessed by the plurality of identities, and a plurality of actions performed on a plurality of resources associated with the plurality of cloud services; transforming the plurality of audit logs to associate each specific action on each specific resource to one of the plurality of accessed services by one of the plurality of identities; generating a map mapping each identity to a plurality of objects, each object including at least one of the plurality of accessed services, at least one performed action, and at least one utilized resource; and generating a report indicating at least one non-utilized authorization for at least one identity by comparing the map to the authorizations granted to each identity.

### BRIEF DESCRIPTION OF THE DRAWINGS

FIG. 1 illustrates an exemplary system for implementing an adaptive permission reduction engine, consistent with some embodiments of the present disclosure.

FIG. 2 illustrates an exemplary computing device, consistent with some embodiments of the present disclosure.

FIG. 3A illustrates an exemplary schematic diagram of an exemplary permission policy, consistent with some embodiments of the present disclosure.

FIG. 3B illustrates an exemplary schematic diagram of an exemplary reduced permission policy after excluding at least one permission from the permission policy of FIG. 3A, consistent with some embodiments of the present disclosure.

FIG. 4 illustrates an exemplary plurality of candidate clustering schemes for a plurality of identities, consistent with some embodiments of the present disclosure.

FIG. 5 illustrates another exemplary plurality of candidate clustering schemes for a plurality of identities, consistent with some embodiments of the present disclosure.

FIG. 6 illustrates an additional exemplary candidate clustering scheme for a plurality of identities, consistent with some embodiments of the present disclosure.

FIG. 7 shows an exemplary flow diagram of an exemplary iterative process for determining a clustering scheme for a plurality of identities, consistent with some embodiments of the present disclosure.

FIG. 8 illustrates an exemplary chart comparing a number of clusters against an average risk margin for a plurality of candidate clustering schemes, consistent with some embodiments of the present disclosure.

FIG. 9 illustrates the exemplary chart of FIG. 8 with a loose solution, a medium solution, and a tight solution, consistent with some embodiments of the present disclosure.

FIG. 10 is an exemplary flow diagram of an exemplary process for managing a plurality of permission policies, consistent with embodiments of the present disclosure.

FIG. 11 is an exemplary flow diagram of another exemplary process for managing a plurality of permission policies, consistent with embodiments of the present disclosure.

FIG. 12 illustrates an exemplary schematic diagram of a system for determining utilized permissions in a cloud computing environment, consistent with some embodiments of the present disclosure.

FIG. 13 is an exemplary flow diagram of an exemplary process for managing a plurality of permission policies, consistent with embodiments of the present disclosure.

### DETAILED DESCRIPTION

Disclosed herein are systems, methods, and non-transitory computer readable media for identity and access management (IAM) planning, based on least privilege principle using machine learning methods. Disclosed embodiments may involve automatic and continuous generation of substantially minimal least privileged roles based on machine learning (ML) clustering of cloud account activity.

Exemplary embodiments are described with reference to the accompanying drawings. The figures are not necessarily drawn to scale. While examples and features of disclosed principles are described herein, modifications, adaptations, and other implementations are possible without departing from the spirit and scope of the disclosed embodiments. For example, with this detailed description provides a few examples, these implementations are provided as examples only and are not restrictive of the claim concepts that follow or any of the descriptions herein. Also, the words “comprising,” “having,” “containing,” and “including,” and other similar forms are intended to be equivalent in meaning and be open ended in that an item or items following any one of these words is not meant to be an exhaustive listing of such item or items or meant to be limited to only the listed item or items. It should also be noted that as used herein and in the appended claims, the singular forms “a,” “an,” and “the” include plural references unless the context clearly dictates otherwise.

Various terms used in the specification and claims may be defined or summarized differently when discussed in connection with differing disclosed embodiments. It is to be understood that the definitions, summaries and explanations of terminology in each instance apply to all instances, even when not repeated, unless the transitive definition, explanation or summary would result in inoperability of an embodiment.

Throughout, this disclosure mentions “disclosed embodiments,” which refer to examples of inventive ideas, concepts, and/or manifestations described herein. Many related and unrelated embodiments are described throughout this disclosure. The fact that some “disclosed embodiments” are described as exhibiting a feature or characteristic does not mean that other disclosed embodiments necessarily share that feature or characteristic.

This disclosure employs open-ended permissive language, indicating for example, that some embodiments “may” employ, involve, or include specific features. The use of the term “may” and other open-ended terminology is intended to indicate that although not every embodiment may employ the specific disclosed feature, at least one embodiment employs the specific disclosed feature.

Disclosed embodiments may include and/or access a data structure. A data structure consistent with the present disclosure may include any collection of data values and relationships among them. The data may be stored linearly, horizontally, hierarchically, relationally, non-relationally, uni-dimensionally, multidimensionally, operationally, in an ordered manner, in an unordered manner, in an object-oriented manner, in a centralized manner, in a decentralized manner, in a distributed manner, in a custom manner, or in any manner enabling data access. By way of non-limiting examples, data structures may include an array, an associative array, a linked list, a binary tree, a balanced tree, a heap, a stack, a queue, a set, a hash table, a record, a tagged union, ER model, and a graph. For example, a data structure may include an XML database, an RDBMS database, an SQL database or NoSQL alternatives for data storage/search such as, for example, MongoDB, Redis, Couchbase, Datastax Enterprise Graph, Elastic Search, Splunk, Solr, Cassandra, Amazon DynamoDB, Scylla, HBase, and Neo4J. A data structure may be a component of the disclosed system or a remote computing component (e.g., a cloud-based data structure). Data in the data structure may be stored in contiguous or non-contiguous memory. Moreover, a data structure, as used herein, does not require information to be co-located. It may be distributed across multiple servers, for example, that may be owned or operated by the same or different entities. Thus, the term “data structure” as used herein in the singular is inclusive of plural data structures.

In the following description, various working examples are provided for illustrative purposes. However, it is to be understood that the present disclosure may be practiced without one or more of these details.

It is intended that one or more aspects of any mechanism may be combined with one or more aspect of any other mechanisms, and such combinations are within the scope of this disclosure.

Various embodiments are described herein with reference to a system, method, device, or computer readable medium. It is intended that the disclosure of one is a disclosure of all. For example, it is to be understood that disclosure of a computer readable medium described herein also constitutes a disclosure of methods implemented by the computer readable medium, and systems and devices for implementing those methods, via for example, at least one processor. It is to be understood that this form of disclosure is for ease of discussion only, and one or more aspects of one embodiment herein may be combined with one or more aspects of other embodiments herein, within the intended scope of this disclosure.

Embodiments described herein may refer to a non-transitory computer readable medium containing instructions that when executed by at least one processor, cause the at least one processor to perform a method. Non-transitory computer readable medium may include any medium capable of storing data in any memory in a way that may be read by any computing device with a processor to carry out methods or any other instructions stored in the memory. The non-transitory computer readable medium may be implemented as hardware, firmware, software, or any combination thereof. Moreover, the software may preferably be implemented as an application program tangibly embodied on a program storage unit or computer readable medium consisting of parts, or of certain devices and/or a combination of devices. The application program may be uploaded to, and executed by, a machine having any suitable architecture. Preferably, the machine may be implemented on a computer platform having hardware such as one or more central processing units (“CPUs”), a memory, and input/output interfaces. The computer platform may also include an operating system and microinstruction code. The various processes and functions described in this disclosure may be either part of the microinstruction code or part of the application program, or any combination thereof, which may be executed by a CPU, whether or not such a computer or processor is explicitly shown. In addition, various other peripheral units may be connected to the computer platform such as an additional data storage unit and a printing unit. Furthermore, a non-transitory computer readable medium may be any computer readable medium except for a transitory propagating signal.

Memory employed herein may include a Random Access Memory (RAM), a Read-Only Memory (ROM), a hard disk, an optical disk, a magnetic medium, a flash memory, other permanent, fixed, volatile or non-volatile memory, or any other mechanism capable of storing instructions. The memory may include one or more separate storage devices collocated or disbursed, capable of storing data structures, instructions, or any other data. The memory may further include a memory portion containing instructions for the processor to execute. The memory may also be used as a working scratch pad for the processors or as a temporary storage.

Some embodiments may involve at least one processor. A processor may be any physical device or group of devices having electric circuitry that performs a logic operation on input or inputs. For example, the at least one processor may include one or more integrated circuits (1C), including application-specific integrated circuit (ASIC), microchips, microcontrollers, microprocessors, all or part of a central processing unit (CPU), graphics processing unit (GPU), digital signal processor (DSP), field-programmable gate array (FPGA), server, virtual server, or other circuits suitable for executing instructions or performing logic operations. The instructions executed by at least one processor may, for example, be pre-loaded into a memory integrated with or embedded into the controller or may be stored in a separate memory.

In some embodiments, the at least one processor may include more than one processor. Each processor may have a similar construction, or the processors may be of differing constructions that are electrically connected or disconnected from each other. For example, the processors may be separate circuits or integrated in a single circuit. When more than one processor is used, the processors may be configured to operate independently or collaboratively. The processors may be coupled electrically, magnetically, optically, acoustically, mechanically or by other means that permit them to interact.

Consistent with the present disclosure, disclosed embodiments may involve a network. A network may constitute any type of physical or wireless computer networking arrangement used to exchange data. For example, a network may be the Internet, a private data network, a virtual private network using a public network, a Wi-Fi network, a LAN or WAN network, and/or other suitable connections that may enable information exchange among various components of the system. In some embodiments, a network may include one or more physical links used to exchange data, such as Ethernet, coaxial cables, twisted pair cables, fiber optics, or any other suitable physical medium for exchanging data. A network may also include a public switched telephone network (“PSTN”) and/or a wireless cellular network. A network may be a secured network or unsecured network. In other embodiments, one or more components of the system may communicate directly through a dedicated communication network. Direct communications may use any suitable technologies, including, for example, BLUETOOTH™, BLUETOOTH LE™ (BLE), Wi-Fi, near field communications (NFC), or other suitable communication methods that provide a medium for exchanging data and/or information between separate entities.

Certain embodiments disclosed herein may also include a computing device for cloud computing, the computing device may include processing circuitry communicatively connected to a network interface and to a memory, wherein the memory contains instructions to be executed. The computing devices may be devices such as mobile devices, desktops, laptops, tablets, or any other devices capable of processing data. Such computing devices may include a display such as an LED display, augmented reality (AR), virtual reality (VR) display.

“Software” as used herein refers broadly to any type of instructions, whether referred to as software, firmware, middleware, microcode, hardware description language, or otherwise. Instructions may include code (e.g., in source code format, binary code format, executable code format, or any other suitable format of code). The instructions, when executed by the one or more processors, may cause the processing system to perform the various functions described in further detail herein.

The one or more processors may be implemented with any combination of general- purpose microprocessors, microcontrollers, digital signal processors (DSPs), field programmable gate array (FPGAs), programmable logic devices (PLDs), controllers, state machines, gated logic, discrete hardware components, dedicated hardware finite state machines, or any other suitable entities that can perform calculations or other manipulations of information.

Aspects of this disclosure may provide technical solutions to challenges associated with managing a cloud computing environment. Disclosed embodiments include methods, systems, devices, and computer-readable media. For ease of discussion, a system is described below with the understanding that the disclosed details may equally apply to methods, devices, and computer- readable media.

A cloud computing environment may refer to a collection of computer system resources, for example data storage (cloud storage) and computing power, which may be available on-demand to one or more users via a network, without requiring direct active management by a user. A cloud computing environment may include multiple hardware and/or software resources (e.g., data centers) distributed over multiple locations. For example, such resources may include infrastructure for performing computations (e.g., computing infrastructure), storing data (e.g., block storage infrastructure), network communication infrastructure, operating systems for managing multiple, distributed computing resources, applications and interfaces (e.g., Application Programming Interfaces) allowing to access cloud resources, and any other infrastructure needed to provide cloud-based services. A cloud computing environment may be provided and/or supported by a cloud vendor. Examples of vendors of cloud computing platforms may include Amazon Web Service®, Microsoft Azure®, Google Cloud Platform®, Alibaba Cloud®, Oracle Cloud®, or IBM Cloud®.

A resource (e.g., a cloud resource) may include computer memory associated with a capability for storing data and/or performing computations, and may be implemented using software (e.g., as a virtual resource) and/or a hardware (e.g., as a physical resource). A resource may include assets such as a data storage facility, processing power, a database, an application, a networking resource, an interface, a data analytics engine, an artificial intelligence engine, a search engine, a software application, an API, a virtual machine, a virtual disk, a document, a bucket, a file, a folder, and/or any other compute resource capable of providing functionality and/or storing data in a cloud computing environment in response to one or more commands.

Some disclosed embodiments involve a permission policy. A permission policy may refer to a set of rules or authorizations associated with a capability to perform and/or restrict performance of one or more activities, e.g., by an identity in a cloud computing environment. In some embodiments, a permission policy may include one or more permitted and/or prohibited activities associated with a resource, a service, an identity, and/or a group of identities. In some instances, a software application provided by a cloud vendor may grant permissions or authorizations to one or more identities as one or more default settings. In some instances, an administrator and/or manager of a cloud computing environment may assign a permission policy to an identity, for example, based on one or more defined roles or responsibilities. At least one processor may store a file containing a permission policy for an identity in memory (e.g., as a JSON file). Authorizations included in a permission policy may be stored using one or more data structures (e.g., as a list or linked list, an array, a table, a hierarchical tree, a graph, and/or any other data structure permitting to define relationships and/or hierarchies). In some embodiments, at least one processor may associate one or more files storing one or more permission policies for one or more identities with one or more unique identifiers associated therewith (e.g., as an index). The at least one processor may subsequently access one or more of the permission policies using the one or more unique identifiers to validate an (e.g., attempted) action by the one or more identities. In a similar manner, at least one processor may associate one or more files storing one or more permission policies for one or more services and/or resources with one or more unique identifiers associated therewith (e.g., as an index). The at least one processor may subsequently access one or more of the permission policies using the one or more unique identifiers to validate an attempt to access the one or more services and/or resources.

Some disclosed embodiments involve an identity. An identity may include any entity (e.g., virtual entity and/or physical entity) capable of performing activities on a cloud computing environment and/or on behalf of which activities may be performed on a cloud computing environment. In some embodiments, an identity may be associated with a unique identifier. An identity may be assigned or otherwise associated with a permission policy granting authorizations to perform certain activities, and/or restricting performance of certain activities. An identity may include a user, a role, a group, a device, an account, a system, an application, and/or any other entity capable of performing activities in a cloud computing environment.

Some disclosed embodiments involve a user. A user may include a person, an account, a customer, an application, and/or an entity operating on behalf of a person, account, a customer, an application, and/or any other entity making use of a cloud computing environment. A user may be associated with a unique identifier (e.g., a phone number, an email address, a social security number, an account ID, a biometric token, an encryption key, a hash value thereof, and/or any other type of unique identifier).

Some disclosed embodiments involve one or more devices. A device may include one or more virtual machines and/or physical machines (e.g., mobile communications device, a server, a proxy device, a laptop computer, a desktop computer, and/or any other computing device) capable of communicating in a cloud computing environment over a communications network. In some embodiments, a device may be identified with a unique identifier and/or an IP address.

Some disclosed embodiments involve a system. A system may include one or more applications (e.g., an operating system, a browser application, a security application, a client software application, a user interface, and/or any other application capable of interacting with a resource), one or more computing devices (e.g., computer networks), and/or any other interactive group of hardware and/or software components capable of interacting with a resource. A second system may include a system other than a system described presently. In some embodiments, a system may be identified with a unique identifier.

Some disclosed embodiments involve a group. A group refers to more than one of something. For example, a group of identities may include a collection of a identities, as described earlier. In some embodiments, a group may refer to a security group delineating areas of a cloud computing environment where different security measures can be applied. In some embodiments, a group may be identified with a unique identifier.

Some disclosed embodiments involve a principle of least privilege. A principle of least privilege (POLP) may refer to a permission policy configured to enforce a minimal level of authorizations (e.g., a lowest clearance level) while allowing an identity to perform their role in an organization.

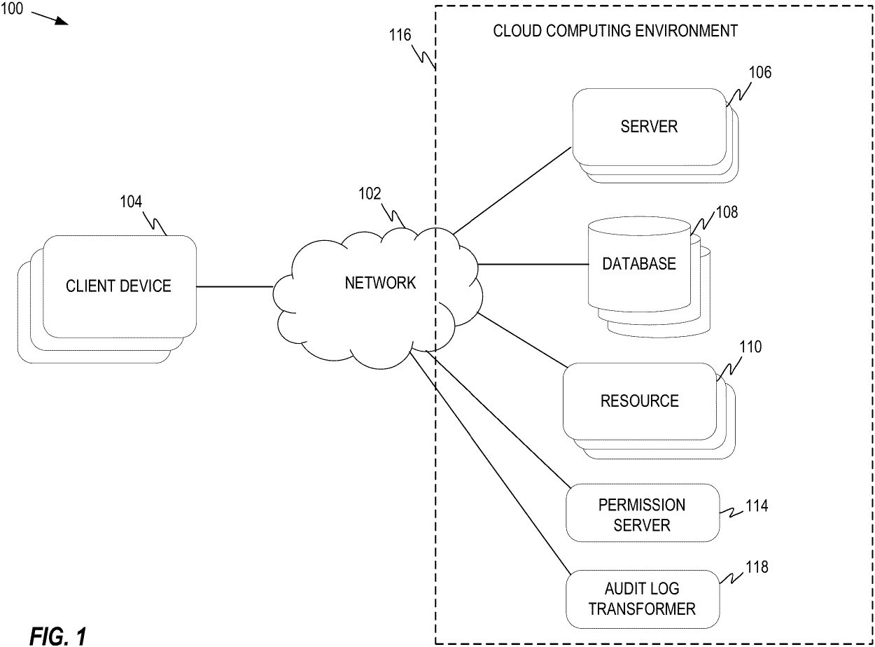

FIG. 1 is a schematic block diagram illustrating an exemplary system 100 for implementing an adaptive permission reduction engine, consistent with some embodiments of the present disclosure. System 100 includes a network 102, at least one client device 104, at least one server 106, at least one database 108, at least one resource 110, a permission server 114, and an audit log transformer 118. At least one server 106, database 108, resource 110, permission server 114, and audit log transformer 118 may be included in a cloud computing environment 116.

Network 102 may be implemented as one or more interconnected data networks. For example, network 102 may include one or more of any type of network (including infrastructure) that provides communications, exchanges information, and/or facilitates the exchange of information, such as the Internet, a Local Area Network, a near field communication (NFC) network, or other suitable connection(s) that enables the sending and receiving of information between the components of system 100. Network 102 may be implemented using wireless connections, wired connections, or both. In some embodiments, one or more components of system 100 can communicate through network 102. In some embodiments, one or more components of system 100 may communicate directly through one or more dedicated communication links. While particular devices and systems are shown as connected to network 102, in some embodiments, more or fewer devices and systems may be connected to network 102.

Client device 104 may be any of a personal computer, a server, a mobile device, a smart device, a home assistant device, a thin client, a tablet, a personal digital assistant, a smartphone, a kiosk, or any other mechanism enabling data input. Client device 104 may be operated to instantiate functionality, access data, or otherwise interact with resource 110 via network 102. Client device 104, in some embodiments, may be any device which enables performance of activities in cloud computing environment 116. Such activities may include, for example, accessing, requesting, viewing, editing, adding, deleting, modifying data, performing functions or causing functions to be performed, and/or perform any other activity in cloud computing environment 116. Activities performed by client device 104 in cloud computing environment 116 may be permitted, restricted, and/or otherwise controlled by one or more permission polices.

At least one server 106, in some embodiments, may be any device which performs functions or stores data, e.g., in response to one or more requests from one or more client devices 104. At least one server 106, in some embodiments, may include one or more of a personal computer, a virtual server, and/or a node in a cluster. In some embodiments, at least one server 106 may be configured to prevent performance of one or more actions requested by one of more of client devices 104, for example, if client devices 104 lack permissions associated with the one or more actions.

Database 108 may include one or more data stores for use by devices and systems in cloud computing environment 116. In some embodiments, database 108 may be implemented as an XML database, an RDDMS database, a SQL database, a NoSQL database, a relational database, a cloud database, a columnar database, a wide column database, a key-value database, an object-oriented database, a hierarchical database, or any other kind of database. In some embodiments, database 108 may be implemented as flat file stores, data stores, or other non-database storage systems. In some embodiments, database 108 may be implemented using one or more of ElasticCache, ElasticSearch, DocumentDb, DynamoDB, Neptune, RDS, Aurora, Redshift clusters, Kafka clusters, or EC2 instances.

Resource 110 may include any type of cloud computing resource (virtual or hardware-based) configured to provide functionality in cloud computing environment 116, and/or access data stored in cloud computing environment 116 in response to requests, e.g., from client device 104. Examples of cloud resources may include a data storage facilities (e.g., buckets, files), databases, applications (e.g., for shared editing of documents), APIs, virtual machines, virtual disks, and/or any other compute resource available in a cloud computing environment.

Permission server 114 may be configured to implement a permission reduction engine (e.g., a machine-learning based adaptive permission reduction engine) to manage a plurality of permission policies associated with a plurality of identities (e.g., a plurality of client devices 104) as described herein in various embodiments. In some embodiments, each of the plurality of identities to perform activities permitted according to each associated permission policy and deny performance of activities restricted by each associated permission policy. Permission server 114 may be implemented as a hardware and/or software (e.g., virtual) computer system. For example, permission server 114 may be integrated within server 106.

Cloud computing environment 116 may be implemented as one or more devices and systems offered by a single cloud service provider. For example, cloud computing environment 116 may include devices and systems that are part of Amazon Web Services, Microsoft Azure, Google Cloud Platform, IBM Cloud, Alibaba Cloud, or any other cloud platform provider. In some embodiments, one or more of the devices and systems in cloud computing environment 116 may require authentication or other identity validation for access. For example, a request to access resource 110 may be required to comply with a permission policy associated with permission server 114. In some embodiments, each of the systems depicted as being inside of cloud computing environment may be implemented as a single physical computer system, multiple physical computer systems, a single virtual computer system, multiple virtual computer systems, or a combination thereof.

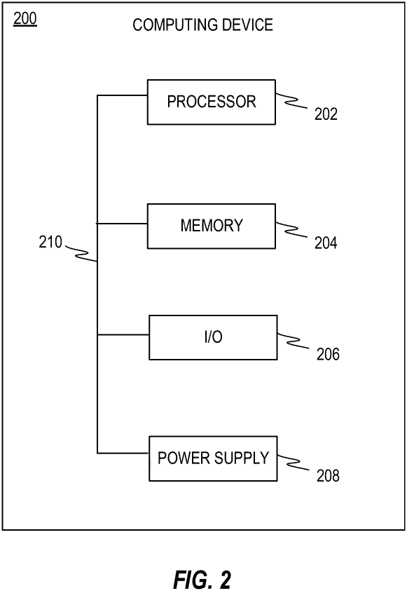

Reference is made to FIG. 2 illustrating an exemplary computing device 200, consistent with some embodiments of the present disclosure. Computing device 200 may be a virtual computing device or a physical computing device. Computing device may be representative of any of at least one client device 104, at least one server 106, database 108, permission server 114, resource 110, and/or any other computing device associated with system 100 or connected to any device in system 100. Computing device 200 includes at least one processor 202, at least one memory 204 (e.g., a non-transitory computer-readable storage medium), an input/output module 206, and a power supply 208. At least one processor 202, at least one memory 204, input/output module 206, and power supply 208 may be connected via a bus system 210.

At least one processor 202 may constitute any physical device or group of devices having electric circuitry that performs a logic operation on an input or inputs. For example, the at least one processor may include one or more integrated circuits (IC), including application-specific integrated circuit (ASIC), microchips, microcontrollers, microprocessors, all or part of a central processing unit (CPU), graphics processing unit (GPU), digital signal processor (DSP), field-programmable gate array (FPGA), server, virtual server, or other circuits suitable for executing instructions or performing logic operations. The instructions executed by at least one processor may, for example, be pre-loaded into a memory integrated with or embedded into the controller or may be stored in a separate memory. The memory may include a Random Access Memory (RAM), a Read-Only Memory (ROM), a hard disk, an optical disk, a magnetic medium, a flash memory, other permanent, fixed, or volatile memory, or any other mechanism capable of storing instructions. In some embodiments, the at least one processor may include more than one processor. Each processor may have a similar construction, or the processors may be of differing constructions that are electrically connected or disconnected from each other. For example, the processors may be separate circuits or integrated in a single circuit. When more than one processor is used, the processors may be configured to operate independently or collaboratively, and may be co-located or located remotely from each other. The processors may be coupled electrically, magnetically, optically, acoustically, mechanically or by other means that permit them to interact.

At least one processor 202 may be configured to perform calculations and computations, such as arithmetic and/or logical operations to execute software instructions, control and run processes, and store, manipulate, and delete data from memory. An example of a processor may include a microprocessor manufactured by Intel™. A processor may include a single core or multiple core processors executing parallel processes simultaneously. It is appreciated that other types of processor arrangements could be implemented to provide the capabilities disclosed herein.

At least one processor 202 may include a single processor or multiple processors communicatively linked to each other and capable of performing computations in a cooperative manner, such as to collectively perform a single task by dividing the task into subtasks and distributing the subtasks among the multiple processors, e.g., using a load balancer. In some embodiments, at least one processor may include multiple processors communicatively linked over a communications network (e.g., a local and/or remote communications network including wired and/or wireless communications links). The multiple linked processors may be configured to collectively perform computations in a distributed manner (e.g., as known in the art of distributed computing).

Memory 204 (e.g., a non-transitory computer-readable storage medium) may include any type of physical memory on which information or data readable by at least one processor can be stored. Examples include Random Access Memory (RAM), Read-Only Memory (ROM), volatile memory, nonvolatile memory, hard drives, CD ROMs, DVDs, flash drives, disks, any other optical data storage medium, any physical medium with patterns of holes, a PROM, an EPROM, a FLASH-EPROM or any other flash memory, NVRAM, a cache, a register, any other memory chip or cartridge, and networked versions of the same. The terms “memory” and “computer-readable storage medium” may refer to multiple structures, such as a plurality of memories or computer-readable storage mediums located locally (e.g., in physical proximity to at least one processor and connected via a local communications link) or at a remote location (e.g., accessible to at least one processor via a communications network). Additionally, one or more computer-readable storage mediums can be utilized in implementing a computer-implemented method. Accordingly, the term computer readable storage medium should be understood to include tangible items and exclude carrier waves and transient signals.

Input/Output unit 206 may include one or more transceivers (e.g., including wired and/or wireless transceivers) configured to enable communication with one or more compute resources (e.g., multiple instances of computing device 200), and/or computer networks (e.g., network 102). For example, input/output unit 206 may include or more antenna configured to communicate using one or more wireless communication protocols (e.g., BlueTooth, Wi-Fi, GPS, Zigbee, 4G, 5G). Input/output unit 206 may be additionally configured to communicate via one or more wires, cables, fibers according to one or more wired communication protocols. Input/output unit 206 may be associated with one or more ports, buffers, interrupt handlers, and any other component required to transmit and/or receive electronic and/or electro-magnetic signals.

Power supply 208 may provide electrical energy to power computing device 200. Power supply 208 may be any device that can repeatedly store, dispense, or convey electric power, including, but not limited to, one or more batteries (e.g., a lead-acid battery, a lithium-ion battery, a nickel-metal hydride battery, a nickel-cadmium battery), one or more capacitors, one or more connections to external power sources, one or more power convertors, or any combination of thereof.

Disclosed embodiments relate to an adaptive permission reduction engine. In some embodiments, the adaptive permission reduction engine may incorporate one or more artificial intelligence algorithms, such as machine learning and/or deep learning algorithms. In some embodiments, the disclosed adaptive permission reduction engine may cluster a plurality of identities in a cloud computing environment based on actual cloud activity, and may continuously and dynamically generate a number of least privileged roles for each cluster to reduce an overall risk margin for the cloud computing environment while providing a reasonable and maintainable number of permission policies to limit management costs. In some embodiments, the disclosed adaptive permission reduction engine may converge to a permission policy (e.g., a substantially optimal permission policy) that may be neither over-provisioned nor under-provisioned, thereby contributing to security while allowing access to resources needed to fulfil responsibilities.

In some embodiments, at least one processor may manage a plurality of permission policies. Managing a plurality of permission polices may involve at least one processor performing one or more operations. Such operations may include collecting a plurality of activities associated with each of a plurality of identities, where each of the identities may correspond to a permission policy, and where each of the activities complies with the permission policy corresponding to the associated identity. Such operations may additionally include calculating a risk margin may for each identity to indicate a gap between the corresponding permission policy and the associated activities. Such operations may further include determining a plurality of candidate clustering schemes for the plurality of identities. Each candidate clustering scheme may include a plurality of distinct non-overlapping clusters corresponding to a partition of the plurality of identities based on a similarity measure of the associated activities. Such operations may additionally include determining a reduced permission policy for at least one distinct non-overlapping cluster of at least one of the plurality of candidate clustering schemes. The reduced permission policy may exclude at least one permission included in the permission policy for at least one identity included in the cluster, while allowing each identity in the cluster to subsequently perform each associated activity. Such operations may additionally include calculating an average risk margin for each candidate clustering scheme based on the at least one reduced permission policy for the at least one cluster. Such operations may further include selecting a specific clustering scheme from the plurality of candidate clustering schemes based on a number of clusters for each candidate clustering scheme and the average risk margin for each candidate clustering scheme.

Some embodiments involve at least one processor implementing a method for managing a plurality of permission policies. A permission may refer to an authorization, accreditation, or clearance to perform an activity. A permission policy may be understood as described elsewhere in this disclosure. A resource (e.g., a cloud resource) may be understood as described elsewhere in this disclosure. A permission policy may permit and/or restrict one or more activities. For example, a permission policy may restrict access to specific data types, specific memory locations, accounts, times or dates, under specific circumstances, and/or impose any other restriction to access a resource. In some embodiments, a permission policy may impose a validation requirement (e.g., using a credential) to perform an activity, and/or restrict activities to specific devices and/or from specific locations. In some embodiments, a permission policy may be stored in a file associated with a resource and/or an identity for subsequent reference to check compliance.

By way of a non-limiting example, in FIG. 1, at least one processor (e.g., processor 202 of FIG. 2 associated with permission server 114) may manage a plurality of permission policies corresponding to a plurality of identities (e.g., associated with one or more of client devices 104).

In some embodiments, at least one associated permission policy imposes a frequency limitation on at least one of the activities. Frequency may refer to a number of occurrences of a repeating event per unit of time. A frequency limitation on an activity may refer to a constraint (e.g., a minimum or maximum) on a number of occurrences of an activity per unit of time. For example, a permission policy may limit how many times a year an identity may access sensitive data (e.g. a maximal limitation), and must change a password (e.g., a minimal limitation).

Managing a permission policy may include storing, securing (e.g., via encryption and/or credential validation), adapting, optimizing, modifying, and/or assigning a permission policy to one or more identities. In some embodiments, managing a permission policy may include at least one processor clustering (e.g., grouping) a plurality of identities, assigning a permission policy to each identity in a cluster, reducing (e.g., restricting), and/or expanding (e.g., relaxing) a permission policy.

By way of a non-limiting example, in FIG. 1, at least one processor 202 (FIG. 2) of permission server 114 may store a plurality of permission policies in memory 204. The plurality of permission policies may be stored as a plurality of electronic files, each associated with a different identity of a plurality of identities.

Some embodiments involve collecting a plurality of activities associated with each of a plurality of identities. An identity may be understood as defined elsewhere in this disclosure. In some embodiments, each identity is associated with at least one of a user, a device, a system, or a group. A user, a device, a system, and a group may be understood as described elsewhere in this disclosure. An activity may refer to an operation performed by at least one processor in association with an identity regarding a resource (e.g., on a cloud computing platform. In some embodiments, an activity may additionally include a service utilized by an identity. An activity may be associated with a data access request (e.g., using an API) for one or more resources. In some embodiments, an activity may be recorded in an audit log (e.g., a record of an audit trail) recording an action performed by an identity in relation to a resource, and/or a service utilized by an identity. Examples of actions performed in relation to a resource may include accessing, reading, writing, storing, sharing, copying, editing, validating, encoding (e.g., encrypting), and/or performing any other operation on data. Collecting may include performing one or more querying, reading, receiving, gathering, storing, and/or aggregating operations. Collecting a plurality of activities associated with a plurality of identities may include at least one processor retrieving and/or storing a plurality of recorded activities performed by or on behalf of one or more identities. In some embodiments, collecting a plurality of activities associated with a plurality of identities may involve at least one processor receiving and storing one or more audit logs (e.g., by ingesting activities into a data pipeline for delivery to a data repository such as a data lake). The at least one processor may collect a plurality of activities (e.g., as a plurality of audit logs) continually or over a time frame (e.g., over an hour, a day, a week, a month, or any other time frame). Each audit log of an audit trail may include information regarding access, usage, and/or operations performed in association with one or more of a resource, an identity, and/or a service on a cloud computing platform. In some embodiments, at least one processor may collect a plurality of activities associated with a plurality of identities (e.g., in an organization) from a cloud computing vendor.

By way of a non-limiting example, in FIG. 1, at least one server 106 may record activities performed in cloud computing environment 116 by a plurality of identities (e.g., multiple instances of client device 104) as one or more audit logs. Permission server 114 may receive the audit logs (e.g., on a continual basis) from server 106, to thereby collect a plurality of activities associated with the plurality of identities.

In some embodiments, each activity includes at least one of requesting data, viewing data, editing data, adding data, deleting data, modifying data, performing a function, or causing a function to be performed. Data may include information encoded as bits and/or bytes. Data may be stored in memory (e.g., including a non-transitory computer readable media) and/or communicated as electronic and/or electro-magnetic signals via an (e.g., wired and/or wireless) communications channel. Examples of data may include records (e.g., financial, health, business, and/or personal) stored in a database, websites stored on a server, documents and files (e.g., text, spreadsheet, graphics, images, video) stored in memory, data packets transmitted via a communications network, electromagnetic signals (e.g., radio) transmitted wirelessly, and/or any other type of digitally encoded information configured for processing by at least one processor. Requesting data may include, for example, querying and/or searching for data (e.g., using an API), receiving data (e.g., using a GET request), and/or performing any other actions for acquiring data. Requesting data may additionally include setting one or more parameters for receiving notifications (e.g., synchronously and/or asynchronously), permitting a computing device to push and/or pull data. Requesting data may comply with one or more communications protocols. Viewing data may involve reading data (e.g., an original version of data or a copy thereof), displaying data, decoding data, and/or any other action permitting to consume encoded information. Editing data may include modifying data (e.g., by adding and/or deleting data), formatting data, and/or performing any other operation for changing data. Adding data may include creating a new electronic file and/or inserting data (e.g., new data) into an existing electronic file. Deleting data may include erasing (e.g., removing) an existing electronic file and/or erasing data from an existing electronic file. Modifying data may include formatting data, encoding data (e.g., encrypting data), compressing data, decompressing (e.g., extracting) data, and/or performing any other operation for changing data. A function may refer to a reusable piece of code (e.g., a series of programing instructions). Performing a function may include executing one or more instructions affecting a compute resource (e.g., affecting data stored in memory). Causing a function to be performed may include executing one or more instruction to invoke a function, for example by calling a function (e.g., an API). In some embodiments, a function call may be associated with one or more arguments, and causing a function to be performed may including specifying one or more arguments and calling a function using the specified arguments. For example, may one or more arguments may affect a performance of an activity on a resource.

In some embodiments, each identity of the plurality of identities corresponds to a permission policy. An identity corresponding to a permission policy may refer to an identity having a permission policy associated therewith and/or assigned thereto (e.g., by an administrator), such that a capability of the identity to perform activities may be restricted by the permission policy. In some embodiments, a permission policy may be assigned to an identity by default (e.g., as a setting of a software application), e.g., based on an account and/or user type. In some embodiments, an administrator may assign a permission policy to an identity. In some embodiments, each activity of the plurality of activities complies with the permission policy corresponding to the associated identity. Complies may refer to satisfying and/or maintaining consistency with one or more rules. Each activity may be associated with an identity, and each identity may be associated with a permission policy, thereby creating a link between each activity by each identity to a permission policy. Each activity by each identity may be supervised for compliance with the associated permission policy.

Some embodiments involve, for each identity, calculating a risk margin indicating a gap between the corresponding permission policy and the associated activities. Calculating may include performing one or more arithmetic and/or logical operations, e.g., by at least one processor. Risk may refer to uncertainty (e.g., measured as a probability or odds), and/or a vulnerability or exposure to one or more threats. Risk in a cloud environment may be associated with, for example, privacy breach, unauthorized access, modification, erasure, copying and/or sharing of data and/or a location in memory, a function and/or an application. A risk margin for an identity may refer to a level of risk associated with a specific identity, e.g., a degree to which one or more resources (e.g., a cloud resource) may be exposed to one or more threats and/or vulnerabilities due to one or more activities performed by or otherwise associated with an identity. A risk margin may be indicative of a gap between a set of activities performed by or on behalf of an identity (e.g., an identity used service X) versus a set of activities that the identity may be permitted to perform (e.g., services X, Y, Z). A wide gap between performed activities versus permitted activities may expose a risk of exploitation of one or more permitted but under-utilized activities. Thus, a risk margin for an identity may be associated with one or more non-performed (e.g., unrecorded) activities that may be subsequently performed in compliance with an existing (e.g., overly permissive) permission policy. At least one processor may calculate a risk margin as one or more of a difference (e.g., by subtracting two values, and/or computing a square thereof), a ratio (e.g., a percent), a probability, an odds, a spread (e.g., standard deviation or variance), an entropy level, and/or any other measure of uncertainty (e.g., associated one or more activities by an identity). A risk margin for an identity may be associated with a risk that a cloud resource may be compromised due to one or more (e.g., inadvertently authorized) activities. A gap may refer to a discrepancy or distance (e.g., an information distance) between two elements or sets of elements. A gap between a corresponding permission policy and associated activities may refer to a discrepancy between activities an identity may be authorized to perform according to a permission policy versus activities that the identity has actually performed. In some embodiments, a gap may be associated with at least one unutilized permission of the associated permission policy. A risk margin may measure, quantify, and/or normalize a risk associated with one or more gaps between one or more permission policies and associated activities, allowing to compare and/or aggregate risk margins associated with different identities and/or groups of identities. An unutilized permission may include an unused or unexploited authorization to perform one or more activities. For example, a default permission policy may authorize an identity to perform activities outside a scope of routine responsibilities, and may inadvertently permit the identity to perform overreaching activities that may compromise of one or more resources. A risk margin may quantify and/or normalize a potential for performing overreaching activities corresponding to a gap between a permission policy and performed activities.

In some embodiments, the gap for each identity corresponds to an efficacy measure of the corresponding permission policy. An efficacy measure for a permission policy may refer to a degree of efficiency, effectiveness, utility, and/or benefit of a permission policy. For example, a large gap may indicate an overly lax permission policy allowing performance of many activities external to routine responsibilities. A large gap may be associated with a high risk margin and consequently, a low efficacy measure. A very narrow gap may indicate an overly constrained permission policy, preventing an identity from performing any activity other than relating to routine responsibilities, and may be associated with a low risk margin and a low efficacy measure. A gap largely limiting an identity to perform activities within a scope of routine responsibilities, while permitting some activities outside the scope, may be associated with a high efficacy measure balancing a need for a low risk margin and permission to perform a range of activities to fulfill routine and non-routine responsibilities. In some embodiments, at least one processor may analyze audit log data to determine an efficacy measure of a set of permission policies associated with a plurality of identities. For example, an efficacy measure may indicate a plurality of identities associated with default permission policies which diverge from a POLP goal, or that some permissions may be unutilized.

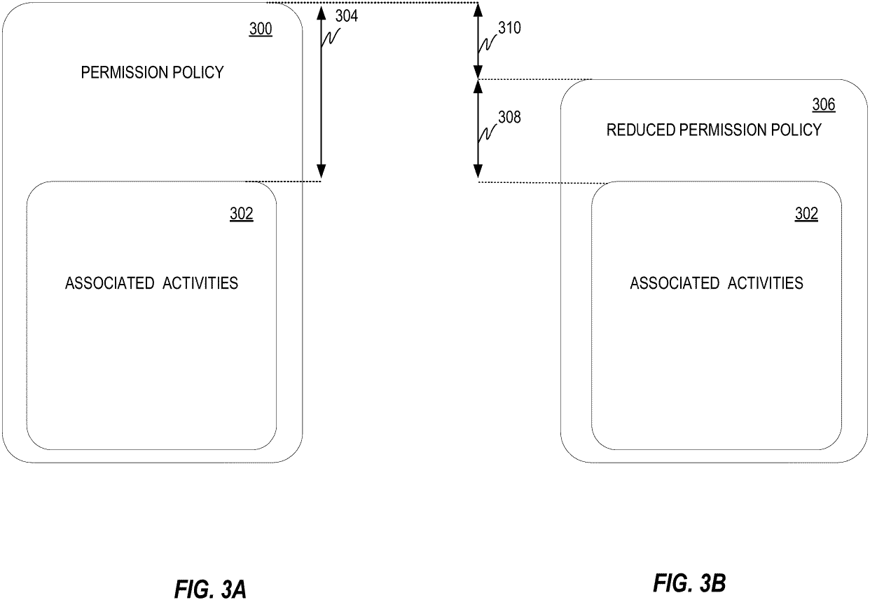

Reference is made to FIG. 3, illustrating a schematic diagram of an exemplary permission policy 300, consistent with some embodiments of the present disclosure. Permission policy 300 may include a plurality of permissions (e.g., corresponding to permitted activities by an identity) and/or a plurality of restrictions (e.g., corresponding to forbidden activities by an identity). Permission policy 300 may correspond to an identity (e.g., client device 104), and may include a subset of associated activities 302 (e.g., recorded activities collected by permission server 114 that were performed by and/or on behalf of the identity). Associated activities 302 may correspond to a subset of utilized permissions of permission policy 300. A risk margin for the identity may be associated with a gap 304 indicating a discrepancy between activities permitted by permission policy 300 versus associated (e.g., performed) activities 302 (e.g., indicating unutilized permissions). For example, gap 304 may include permissions external to routine activities required by the identity to fulfill responsibilities.

Some embodiments involve at least one processor organizing the collected plurality of activities according to services, actions, and resources, thereby associating each identity with at least one of a service, an action, or a resource. Organizing may include sorting, grouping (e.g., binning), and/or ordering. Associated may refer to a bi-directional relationship between two or more elements, such that if an activity is associated with a service, action, or a resource, the service, action, or resource may be associated with the activity. An action may refer to an atomic unit of step in a work flow, where multiple actions may be combined (e.g., in a sequence) to form an activity. Organizing a plurality of activities according to services, actions, and resources may include grouping or binning subsets of the plurality of activities according to associated services, actions, and resources. Grouping the plurality of activities thus may associate each identity (e.g., associated with an activity) with at least one of a service, an action or a resource. In some embodiments, the risk margin for each identity further indicates a gap between the permission policy corresponding to the identity and the at least one services, actions, or resources associated with the identity. Corresponding may refer to a bi-directional relationship such that if a permission policy corresponds to an identity, the identity corresponds to the permission policy. Associating each identity with at least one of a service, an activity, or a resource may allow at least one processor to determine a gap between a permission policy for an identity in relation to at least one of a service, an activity, or a resource. For example, the gap may indicate underutilized and/or unnecessary activities permitted in relation to a service, or resource.

In some embodiments, the at least one service is a cloud storage service. Cloud storage may refer to one or more remote data storage devices that may be accessible via a communications network. Cloud storage may be elastic and scalable, allowing a client computing device to increase and/or decrease an amount of utilized storage capacity. Cloud storage may include redundancy for backing up data in case one or more storage devices fail. A cloud storage service may include infrastructure allowing a client computing device to access cloud storage in a seamless manner by integrating a cloud storage user interface with an operating system running on the client computing device. A cloud storage service may be implemented with one or more server computing devices, responding to requests from one or more client computing devices over a communications network.

In some embodiments, the at least one resource includes at least one of a virtual resource, a physical resource, a function providing resource, or a data storage resource. A virtual resource may include a resource implemented using software that emulates (e.g., simulates) a hardware resource. A physical resource may include a hardware resource (e.g., including one or more electronic components such as a CPU, a GPU, a memory device, a bus, and/or any other electronic component included in a computing resource). A function providing a resource may refer to an interface (e.g., an application programming interface) allowing to access to one or more resources (e.g., as a function call). A data storage resource may include object storage, file storage, and/or block storage.

By way of a non-limiting example, in FIG. 1, at least one server 106 and/or database 108 may provide one or more cloud storage services. At least one resource 110 may include a virtual resource (e.g., a virtual machine), a physical resource (e.g., a physical machine), a function providing a resource (e.g., an API for receiving data from cloud computing environment 118), and/or a data storage resource.

Some embodiments involve determining a plurality of candidate clustering schemes for the plurality of identities each candidate clustering scheme includes a plurality of distinct non-overlapping clusters corresponding to a partition of the plurality of identities based on a similarity measure of the associated activities. A cluster may refer to a collection of a plurality of associated elements (e.g., elements exhibiting one or more shared characteristics, for instance based on a similarity measure). Clustering may include a mathematical method for splitting a data set of N samples into K different groups, each group sharing one or more common characteristics. One goal of a clustering may include maximizing a similarity measure between members of a cluster, while minimizing a similarity measure between different clusters. Distinct clusters may refer to distinguishable, separate (e.g., identifiably separate), and/or exclusive clusters. Non-overlapping clusters may refer to clusters lacking any common or shared element with any other cluster. A partition of a plurality of identities may refer to an organization of a plurality of identities into a plurality of non-empty subsets, such that each identity included in exactly one subset. A similarity measure of associated activities may refer to an affinity, a correspondence, an association, and/or a shared characteristic between two or more activities. In some embodiments, a similarity measure may be determined based on a distance (e.g., an information distance) measure between a plurality of items falling within a threshold, for example, a Euclidian distance, a least-squares distance, Minkowski distance, and/or a Manhattan distance. In some embodiments, each identity in a cluster may be associated a substantially similar set of activities (e.g., similar actions, in relation to similar resources, services, and/or contexts). Clustering identities based on a similarity measure of activities may allow applying a same (e.g., common) permission policy to each identity in a cluster.

In some embodiments, determining the plurality of candidate clustering schemes is further based on the determined associations between each activity and the at least one service, action, or resource. For example, at least one processor may base a similarity measure for clustering identities on access requests for a specific resource, service or type thereof, a specific application or interface or type thereof, and/or specific actions (e.g., steps) included in one or more activities. Additionally or alternatively, at least one processor may base a similarity measure for clustering identities on activities performed at certain times or dates, use cases or contexts, a ranking or a priority of an activity, a sequence or group of activities, a location, an account, a device or type of device, a communications channel or type thereof, and/or any other characterizing feature of an activity.

A clustering scheme for a plurality of identities based on a similarly measure of associated activities may refer to an organization of a plurality of identities into distinct non-overlapping clusters such that each identity is included in exactly one cluster, and identities in any given cluster may related based on a similarity measure of associated activities. For example, at least one processor may cluster a set of identities based on associated activities for accessing a certain category of resources, for performing certain activities at certain times or locations, via certain channels, and/or at certain frequencies. A candidate clustering scheme may refer to a proposed, or potential clustering scheme. A plurality of candidate clustering schemes for a plurality of identities may include multiple differing clustering schemes, each organizing the same plurality of identities into a different plurality of clusters. In some embodiments, two or more candidate clustering schemes may include the same number of different clusters (e.g., different partitions of the plurality of identities into the same number of clusters). In some embodiments, determining the plurality of candidate clustering schemes includes at least one processor applying at least one of a K-means clustering, an unsupervised learning clustering, a Density-Based Spatial Clustering of Applications with Noise clustering, or a hierarchical clustering to the plurality of identities. A K-means clustering may refer to a clustering method that divides a data set of N elements into K clusters. In some embodiment, at least one processor may implement a K-means clustering method by assigning an element to a cluster based on a nearest distance to a mean (e.g., average) measurement characterizing the cluster. A K-means algorithm may cluster N elements by separating the N elements into K groups of equal variance, where each cluster may be associated with a centroid minimizing an inertia of the cluster, within a sum-of-squares criterion, e.g.:

$${\sum }_{i = 0}^{n} {min}_{{μ}_{j} ∈ C} \left({\left‖{x}_{i} - {μ}_{j}\right‖}^{2}\right)$$

An unsupervised learning clustering may refer to a clustering method based on discerning patterns in untagged or un-annotated data. A Density-Based Spatial Clustering of Applications with Noise Clustering (DBSCAN) may refer to a clustering method capable of determining clusters in noisy data including outliers. A hierarchical clustering may refer to a clustering method that organizes a plurality of clusters into a ranking or hierarchy. In some embodiments, at least one processor may dynamically select a clustering method for partitioning the plurality of identities into distinct non-overlapping clusters, and/or according to a demand for determining a fit (e.g., a “best fit”) between a set of permission policies and the collected activities. For example, during a first time interval, at least one processor may use a K-means clustering method to cluster the plurality of identities, and during a second time interval, at least one processor may use a DBSCAN clustering method, e.g., based on a determination of a noisy data set. In some embodiments, each candidate clustering scheme includes a differing number of distinct non-overlapping clusters. For example, at least one processor may order the candidate clustering schemes in increasing order of number of clusters, such that any subsequent candidate clustering scheme includes a greater number of clusters than a prior candidate clustering scheme. In some embodiments, for at least one of the plurality of candidate clustering schemes, a number of distinct non-overlapping clusters included in the at least one candidate clustering scheme equals a number of permission policies. Equal may refer to matching or equivalent. For example, one candidate clustering scheme may cluster the plurality of identities based on corresponding permission policies. Alternatively, two or more clusters in a candidate clustering scheme may be associated with two of more permission policies, but the total number of clusters may match the total number of permission policies. In some embodiments, for at least one of the plurality of candidate clustering schemes, a number of distinct non-overlapping clusters included in the at least one candidate clustering scheme is less than a number of permission policies. For example, two or more clusters in a candidate clustering scheme may be assigned the same permission policy.

In some embodiments, at least one processor may base a number of clusters in a candidate clustering scheme on a risk margin measure and a number of clusters, where the number of clusters may be associated with a number of permission polices. The at least one processor may select a number of clusters to strike a balance between a cost associated with managing a plurality of permission policies and an average risk margin resulting from applying the plurality of permission policies. For example, few clusters, associated with few permission policies may be associated with a low management cost, but a higher average risk margin due to a larger gap between any one permission policy and activities associated therewith. By contrast, many clusters, associated with many permission policies may be associated with a high management cost, and a lower average risk margin due to a smaller gap between any one permission policy and activities associated therewith.

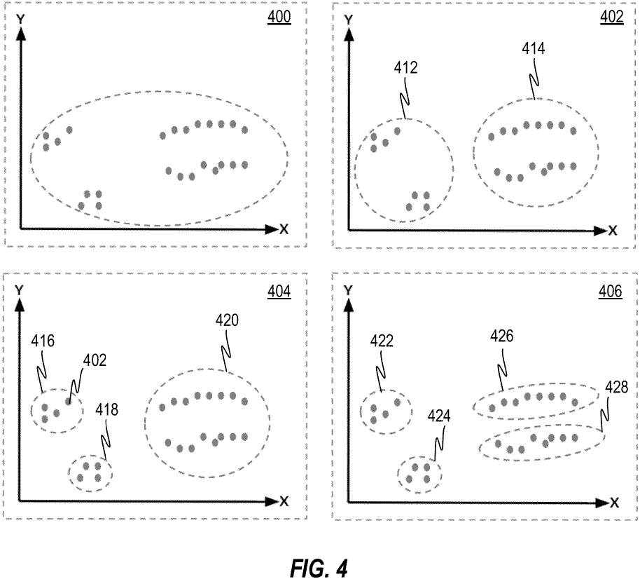

Reference is made to FIG. 4, illustrating an exemplary plurality of candidate clustering schemes 400, 402, 404, and 406 for a plurality of data points 408, consistent with some embodiments of the present disclosure. The plurality of data points may represent a plurality of identities. At least one processor (e.g., processor 202 associated with permission server 114) may determine candidate clustering schemes 402, 404, and 406 to include a plurality of distinct non-overlapping clusters corresponding to a partition of the plurality of identities based on a similarity measure of associated activities. Each of candidate clustering schemes 402, 404, and 406 may partition the plurality of identities into a differing number of non-overlapping clusters. For instance, candidate clustering scheme 402 includes two distinct non-overlapping clusters 412 and 414, candidate clustering scheme 404 includes into three distinct non-overlapping clusters 416, 418, and 420, and candidate clustering scheme 406 includes four distinct non-overlapping clusters 422, 424, and 426, and 428. In some embodiments, differing clustering schemes (e.g., clustering schemes 402 and 404) may include one or more substantially similar clusters (e.g., identical clusters 414 and 420). In some embodiments, one or more candidate clustering schemes (e.g., clustering scheme 408) may include one or more unique clusters (e.g., unique clusters 420 and 422).

In some embodiments, at least one processor may base candidate clustering schemes 400 to 406 on associations determined between activities by the plurality of identities and resources 110. In some embodiments, at least one processor may determine each of candidate clustering schemes 402 to 406 using the same clustering method. In some embodiments, at least one processor may determine at least some of candidate clustering schemes 402 to 406 using differing clustering methods. For example, candidate clustering scheme 402 may be determined using K-means clustering, candidate clustering scheme 404 may be determined using an unsupervised learning technique, candidate clustering scheme 406 may be determined using DBSCAN clustering.

For example, the at least one processor may determine two permission policies for clusters 412 and 414 (e.g., one permission policy per cluster of candidate clustering scheme 402), and four permission policies for clusters 416, 418, and 420 (e.g., two permission polices for cluster 420, resulting in fewer permission policies than clusters for candidate clustering scheme 404).

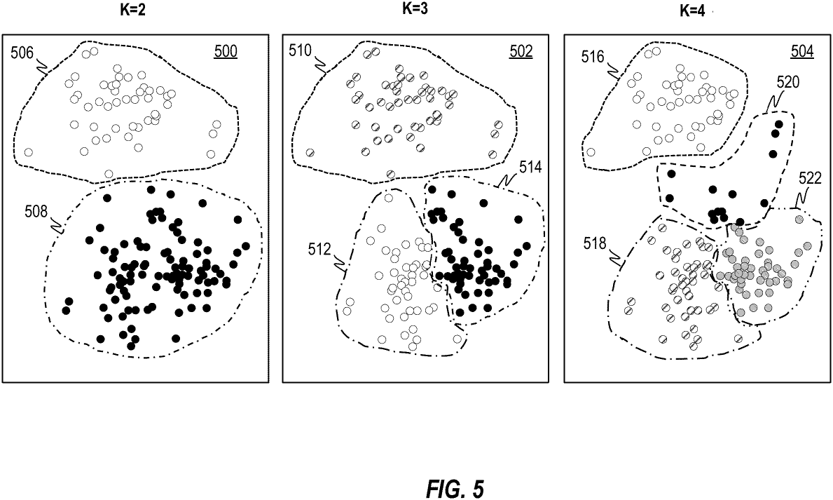

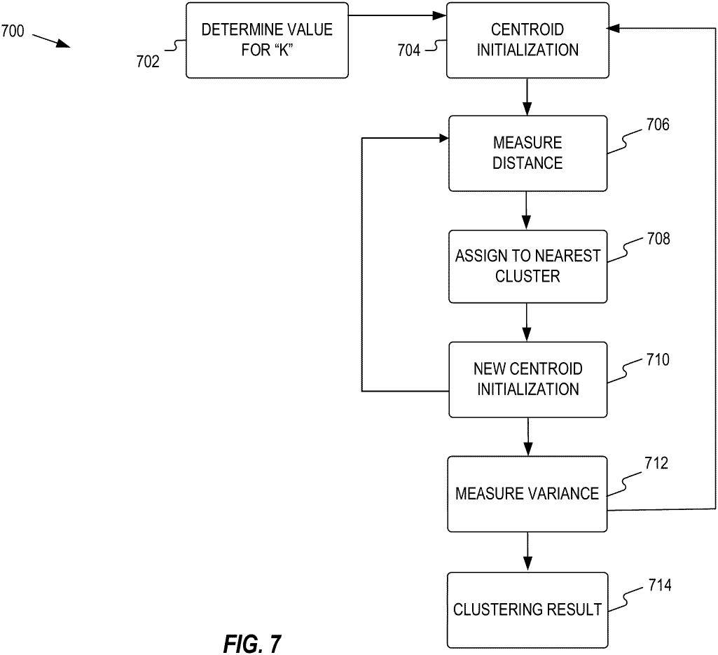

Reference is made to FIG. 5, illustrating another exemplary plurality of candidate clustering schemes 500, 502, and 504 for a plurality of identities, consistent with some embodiments of the present disclosure. Candidate clustering scheme 500 may include two non-overlapping clusters 506 and 508. Candidate clustering scheme 502 may include three non-overlapping clusters 510, 512, and 514. Candidate clustering scheme 504 may include four non-overlapping clusters 516, 518, 520, and 522. In some embodiments, two different candidate clustering schemes (e.g., having a different number of clusters and/or including at least some different clusters) may include one or more identical clusters, for example, cluster 506 of clustering scheme 500 may be identical to clustering scheme 510. Candidate clustering schemes 500, 502, and 504 may be determined, for example, using a POLP machine-learning clustering method described below with respect to FIG. 7.

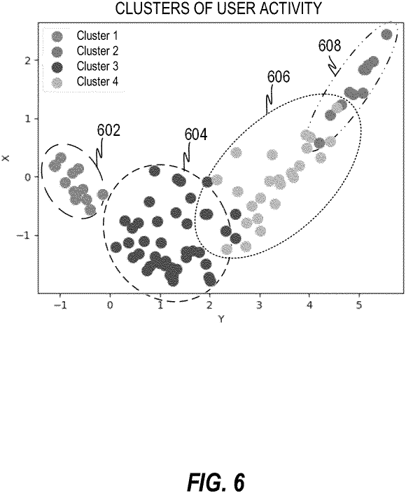

Reference is made to FIG. 6, illustrating an additional candidate clustering scheme 600 for a plurality of identities, consistent with some embodiments of the present disclosure. Candidate clustering scheme 600 may include four clusters 602, 604, 606, and 608 which may be determined, for example, using the OLP machine-learning clustering method of FIG. 7.

Reference is made to FIG. 7 showing an exemplary flow diagram of an exemplary iterative process 700 for determining a clustering scheme for a plurality of identities using machine learning, consistent with some embodiments of the present disclosure. In some embodiments, process 700 may be performed by at least one processor (e.g., processing device 202) to perform operations or functions described herein. In some embodiments, some aspects of process 700 may be implemented as software (e.g., program codes or instructions) that are stored in a memory (e.g., memory 204) or a non-transitory computer readable medium. In some embodiments, some aspects of process 700 may be implemented as hardware (e.g., a specific-purpose circuit). In some embodiments, process 700 may be implemented as a combination of software and hardware. Process 700 may include steps 702 to 712, some or all of which may be implemented using a machine learning engine.

Process 700 may include a step 702 of determining a number of clusters for partitioning a plurality of identities. For example, at least one processor may use one or more clustering methods (e.g., centroid based clustering, K-means and/or DBscan clustering, density-based clustering, distribution-based clustering, hierarchical clustering, and/or any other type of clustering) to partition a plurality of identities. In some embodiments, the at least one processor may determine a value for K for a K-means clustering method. Process 700 may include a step 704 of initializing a centroid for each of the K clusters. For example, at least one processor may select a centroid randomly, based on an average or mode for a plurality of activities, or using any other centroid selection technique. Process 700 may include a step 706 of determining a distance between each identity and the determined centroid. For example, at least one processor may base a distance on a similarity measure of activities associated with each identity and each centroid. At least one processor may compute a distance, for example, as an information distance, a Hamming distance, a Euclidian distance, a least-squares distance, Minkowski distance, and/or a Manhattan distance. Process 700 may include a step 708 of assigning each identity to a cluster based on a minimal distance of associated activities to a centroid of the cluster. Maintaining an (e.g., substantially) minimal distance to a centroid may ensure similarity of associated activities for clustered identities. Process 700 may include a step 710 of calculating a new centroid for each cluster. At least one processor may calculate a new centroid, for example, using a machine learning algorithm. Some examples of machine learning algorithms may include supervise, unsupervised, and/or semi-supervised learning, reinforced learning, linear regression, logistic regression, decision trees, random forests, neural networks, support vector machines, and/or Naïve Bayes algorithms. In some embodiments, after performing step 710, process 700 may include at least one processor repeating additional performances of steps 706 and 708 (e.g., in an iterative manner), for example, until an iteration threshold is reached or until a convergence is reached. For example, at least one processor may base convergence on an average distance between a plurality of identities (and activities associated therewith) and a centroid of a cluster. Once an average distance ceases to decrease above a threshold amount, the at least one processor may determine convergence has been reached. Process 700 may include a step 712 of measuring a variance for each cluster. For example, at least one processor may determine a variance as an average distance between each identity (and activities associated therewith) assigned to a cluster and a centroid of the cluster. In some embodiments, after performing step 712, process 700 may include at least one processor repeating one or more additional performances of steps 704 to 710, until a sum of the variances for the K clusters is beneath a threshold value. After a sum of the variances for the K clusters is beneath the threshold value, process 700 may include a step 714 of outputting a result of the clustering method, where each identity is assigned to only one of the K clusters.

Some embodiments involve, for at least one distinct non-overlapping cluster of at least one of the plurality of candidate clustering schemes, determining a reduced permission policy. A reduced permission policy may refer to a permission policy modified by removal of at least one authorization (e.g., included in the non-reduced permission policy) and/or including at least one restriction (e.g., omitted from the non-reduced permission policy). For example, a reduced permission policy may remove write privileges from certain resources while maintaining read privileges, or remove access to resources via public channels and/or impose validation using a credential. As another example, a reduced permission policy may restrict access to certain resources from specified (e.g., secure and/or private) locations, and/or at certain times (e.g., during working hours). Determining a reduced permission policy for a cluster may involve at least one processor determining a collective set of activities containing all activities associated with each identity in a cluster (e.g., based on a union of activities associated with each identity in a cluster), including in a permission policy for a cluster any permissions and/or authorizations required and/or otherwise associated with performing any activity included in the collective set of activities, and removing from a permission policy from a cluster at least one permission and/or authorization immaterial to and/or lacking association with any activity included in the collective set of activities. Consequently, a reduced permission policy for a cluster may allow subsequent performance of each activity in the collective set by any identity in the cluster and may restrict performance of at least one activity excluded from the collective set. In some embodiments, a reduced permission policy for a cluster may only permit activities contained in a collective set for a cluster (e.g., a minimal permission policy). In some embodiments, a reduced permission policy for a cluster may be associated with an identity in the cluster (e.g., the most restrictive permission policy, or a permission policy other than the most permissive permission policy in the cluster). In some embodiments, a reduced permission policy for a cluster may permit activities contained in a collective set for the cluster, and at least one additional activity (e.g., excluded from the set). The additional activity may be added based on one or more of a similarity measure to the activities of the set, a predictive model, and/or any other criterion for permitting one or more activities. For example, a reduced permission policy may include an activity expected to be performed intermittently (e.g., a password update) even if absent from the collective set of activities. In some embodiments, a reduced permission policy may be determined for a single cluster. In some embodiments, a reduced permission policy may be determined for at least some clusters. In some embodiments, a reduced permission policy may be determined for each cluster of a single candidate clustering scheme. In some embodiments, a reduced permission policy may be determined for each of multiple clusters of multiple candidate clustering schemes.

Some embodiments involve the reduced permission policy excluding at least one permission included in the permission policy for at least one identity included in the cluster, while allowing each identity in the cluster to subsequently perform each associated activity. A reduced permission policy excluding a permission included in the permission policy for an identity may omit at least one previously included authorization, and/or may include at least one previously omitted restriction. Excluding a permission from a permission policy may involve deleting a permission from an electronic file and/or creating a new electronic file omitting a permission. For example, a permission policy may allow an identity to access a resource from public locations, whereas a reduced permission policy may limit access to the resource from a private location. Allowing may include permitting, enabling, and/or granting (e.g., permission). Subsequently may refer to following, or afterwards, e.g., at a later time. Allowing each identity in the cluster to subsequently perform each associated activity may involve reducing a permission policy in a manner that avoids interference with a subsequent performance of any of the associated activities by any identities in the cluster. For example, a reduced permission policy for a cluster may remove a permission for an activity external to a collective set of associated activities for the cluster, allowing the identities in the cluster to subsequently perform any activity in the collective set.

In some embodiments, reducing a permission policy for a cluster may reduce a risk margin for at least one identity in the cluster (e.g., a risk margin under a reduced permission policy may be smaller than a risk margin under a non-reduced permission policy). This may be due to the reduced permission policy reducing a gap between permitted activities (e.g., that may be subsequently performed) versus the (e.g., previously performed) associated activities. For instance, the reduced permission policy may remove one or more non-utilized permissions associated with one or more non-performed activities. Since identities may be clustered based on a similarity measure of associated activities, in some embodiments, reducing a permission policy for a cluster may reduce a risk margin for a plurality of identities in the cluster, e.g., causing a reduction of an aggregated risk margin for the cluster. In some embodiments, a reduced permission policy may reduce a risk margin for each identity in the cluster.

Some embodiments involve calculating an average risk margin for each candidate clustering scheme based on the at least one reduced permission policy for the at least one cluster. Calculating an average risk margin for a clustering scheme may include calculating a risk margin for at least some identities of the plurality of identities, aggregating or combining the calculated risk margins, and/or computing one or more statistical measures thereof. Such statistical measure may include, a mean, a mode, a spread, a standard deviation, a skew, a minimum, a maximum, an entropy value, and/or any other statistical measure of aggregated risk. In some embodiments, calculating an average risk margin for a clustering scheme may involve aggregating a risk margin for each identity of the plurality of identities partitioned by the clustering scheme. In some embodiments, an average risk margin for a clustering scheme may be aggregated over a time period (e.g., at least an hour, a day, a week, or one month).

By way of a non-limiting example, in FIGS. 3A-3B, at least one processor (e.g., processor 202 of permission server 114) may determine reduced permission policy 306 for at least one cluster of at least one candidate clustering scheme (e.g., cluster 416 of candidate clustering scheme 404). Reduced permission policy 306 may exclude at least one permission of permission policy 300 for identity 402 included in cluster 416, while allowing each identity in cluster 416 to subsequently perform each of (e.g., previously performed) associated activities 302, e.g., by removing a permission of permission policy 300 associated with an activity excluded from associated activities 302.

Reduced permission policy 306 may include fewer permissions than permission policy 300, causing a gap 308 between reduced permission policy 306 and associated activities 302 to be smaller than gap 304 between (e.g., non-reduced) permission policy 300 and associated activities 302 a distance 310 (e.g., a fit between associated activities 302 and reduced permission policy 306 may be smaller than with permission policy 300). Gap 304 may be indicative of a risk margin for an identity under permission policy 300, whereas gap 308 may be indicative of a risk margin an identity under reduced permission policy 306, such that a risk margin under reduced permission policy 306 may be smaller than a risk margin under permission policy 300.

Calculating an average risk margin for a clustering scheme based on at least one reduced permission policy for at least one cluster may involve calculating an average risk margin, as described earlier, where for at least one cluster of the clustering scheme, a risk margin for each identity in the cluster may be based on a gap between activities permitted under a reduced permission policy for the cluster versus (e.g., previously performed) activities associated with each identity in the cluster. Reducing a gap using a reduced permission policy may reduce an aggregated risk margin for a cluster. In some embodiments, an average risk margin for a candidate clustering scheme may be based on a reduced permission policy for a single cluster, for at least some clusters, or for each cluster of the candidate clustering scheme.

By way of a non-limiting example, in FIGS. 3A-3B, the at least one processor (e.g., processor 202 of permission server 114) may calculate an average risk margin for each candidate clustering scheme (e.g., see candidate clustering schemes 400 to 406 in FIG. 4) based on at least reduced permission policy 306. For example, the average risk margin for candidate clustering scheme 404 may account for gap 308 under reduced permission policy 306 being smaller than gap 304 under (e.g., non-reduced) permission policy 300 by distance 310.

Some embodiments involve selecting a specific clustering scheme from the plurality of candidate clustering schemes based on a number of clusters for each candidate clustering scheme and the average risk margin for each candidate clustering scheme. Selecting may include choosing, filtering, and/or designating. A specific clustering scheme may refer to a particular (e.g., chosen) clustering scheme from a plurality of candidate clustering schemes. At least one processor may select a specific clustering scheme based on a trade-off between having a small number of clusters (e.g., and a corresponding small number of permission policies to enforce) while maintaining an overall risk margin beneath a threshold level. Such a trade-off may be associated with a point of diminishing returns for reducing overall risk margin by increasing a number of clusters, where selecting a clustering scheme having more clusters than the selected clustering scheme may fail reduce an overall risk margin by a threshold amount. A number of clusters for each candidate clustering scheme may refer to how many clusters (e.g., a cardinality of clusters) included in each clustering scheme. In some embodiments, a number of clusters in a clustering scheme may be associated with an efficiency measure for managing a plurality of permission policies in a cloud computing environment. For instance, a candidate cluster scheme having a large number (e.g., many) clusters may be associated with a large number of permission policies, leading to a better fit between each permission policy for each identity for a smaller average risk margin. However, managing each permission policy may incur a cost. Thus, many permission policies (e.g., corresponding to many clusters) may incur higher management costs. Basing a selection of a specific clustering scheme on a number of clusters and an average risk margin may balance a tradeoff between achieving a smaller average risk margin with management costs.

By way of a non-limiting example, in FIG. 4, the at least one processor (e.g., processor 202 of permission server 114) may select clustering scheme 404 from plurality of clustering schemes 400 to 406 based on the number of clusters in each of candidate clustering schemes 400 to 406 and the average risk margin for each.

In some embodiments, a candidate clustering scheme may be selected based on a selection of clusters associated with permission policies having a substantially minimal number of permissions (e.g., a substantially minimal gap between each permission policy and activities associated therewith). In some embodiments, a candidate clustering scheme may be selected based on clusters being associated with POLP permission polices.

In some embodiments, selecting the specific candidate clustering scheme from the plurality of candidate clustering schemes includes ordering the plurality of candidate clustering schemes based on a number of clusters included in each candidate clustering scheme. Ordering may include arranging according to a pattern (e.g., based on increasing or decreasing ordinality). Ordering a plurality of candidate clustering schemes based on a number of clusters included in each candidate clustering scheme may include arranging the plurality of candidate clustering schemes in a sequence of increasing or decreasing number (e.g., ordinality) of clusters in each candidate clustering scheme. Some embodiments involve, for at least one adjacent pair of the ordered candidate clustering schemes, calculating a change between the average risk margins for the candidate clustering scheme in the adjacent pair. An adjacent pair of ordered candidate clustering schemes may refer to two neighboring candidate clustering schemes in a plurality of candidate clustering schemes arranged according to an (e.g., increasing or decreasing) sequence of a number of clusters per candidate clustering scheme. A change between average risk margins for an adjacent pair of candidate clustering schemes may include a distance (e.g., a difference, an absolute value, and/or a square of a difference), a fraction, a delta, and/or any other measure differentiating between the average risk margins for the adjacent candidate clustering schemes. Some embodiments involve, selecting one of the candidate clustering schemes of the adjacent pair of ordered adjacent candidate clustering schemes when the change is less than a threshold change in risk margin. A threshold may refer to a limit or baseline (e.g., a maximum or minimum). A change less than a threshold change of risk margin may refer to a difference between two risk margins being less than an upper baseline difference. For example, a change less than a threshold change may indicate diminishing returns in an effectiveness measure for reducing an average risk margin versus cost associated with a larger number of clusters, corresponding to a large number of permission policies to be managed.

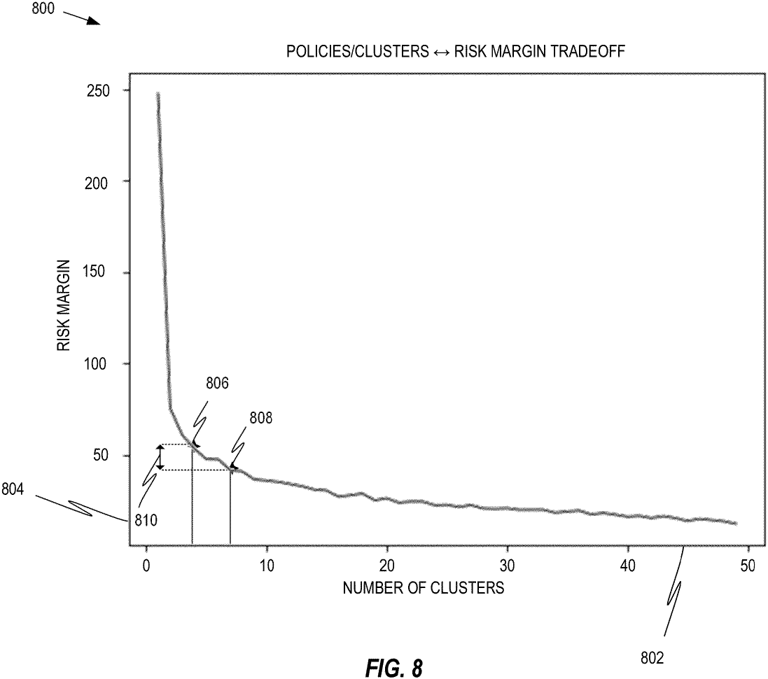

Reference is made to FIG. 8 illustrating an exemplary chart 800 comparing a number of clusters against an average risk margin for a plurality of candidate clustering schemes, consistent with some embodiments of the present disclosure. Chart 800 includes an x-axis 802 corresponding to a number of clusters for each candidate clustering scheme and a y-axis 804 corresponding to a risk margin for each candidate clustering scheme. The at least one processor (e.g., processor 202 of permission server 114) may order a plurality of candidate clustering schemes (e.g., see candidate clustering schemes 400 to 406 in FIG. 4) based on a number of clusters included therein. For at least one adjacent pair of ordered candidate clustering schemes (e.g., clustering schemes 402 and 404), the at least one processor may calculate a change 810 between the average risk margins 806 and 808 for the adjacent pair of candidate clustering schemes. The at least one processor may select a specific clustering scheme (e.g., clustering scheme 402) when change 810 is less than a threshold change. For example, the specific clustering scheme may correspond to a “knee” in graph 800 indicating a point of diminishing returns for increasing a number of clusters compared to a reduction in average risk margin. The specific clustering scheme may represent a tradeoff between finding a clustering scheme having a minimal number of clusters to reduce management costs while reducing an average risk margin.

Some embodiments involve applying the permission policies of the selected clustering scheme to the plurality of identities such that each identity is permitted to perform activities in compliance with the permission policy of the selected clustering scheme while being forbidden to perform activities that violate the permission policy of the selected clustering scheme. Applying a permission policy of a selected clustering scheme may include at least one processor creating a correspondence between each permission policy for each cluster (e.g., including any reduced permission policies) and each identity included therein, referring to a permission policy upon detecting an attempt by identity associated therewith to perform an activity, and blocking an activity violating a permission policy. At least one processor may create a correspondence between a permission policy for a cluster and each identity in the cluster, for example, by storing the permission policy in memory in association with a unique identifier for each identity of the cluster (e.g., as an index), allowing the at least one processor to subsequently access the permission policy upon detecting an attempted action by any one of the identities. In some embodiments, applying permission policies to a plurality of identities may be restricted to an administrator in a cloud computing environment.

Updating a permission policy for an identity may involve at least one processor replacing a file (e.g., a JSON file) storing an obsolete permission policy with a new file storing a current permission policy in memory, and/or editing an existing (e.g., JSON) file storing a permission policy. Updating a permission policy may affect one or more assets in a cloud computing environment, such as one or more data storage services (e.g., an S3 bucket), interfaces (e.g., APIs), functions (e.g., lambda functions), databases, and/or any other asset in a cloud computing environment. Permitting an identity to perform activities in compliance with a permission policy of the selected clustering scheme may involve at least one processor locating a permission policy for an identity in memory, searching a permission policy for an attempted activity, determining that an attempted activity may be permitted by a permission policy, and/or allowing performance of the attempted activity. In some embodiments, an identity may be unaware of a permission policy when performing a permitted activity. Forbidding an identity to perform activities that violate the permission policy of the selected clustering may involve at least one processor locating a permission policy for an identity in memory, searching a permission policy for an activity attempted, determining that an attempted activity may be restricted by a permission policy, and/or denying performance of an attempted activity, for example, by issuing an error notification indicating a permission policy violation.

Some embodiments involve for at least one cluster included in the selected clustering scheme, upon detecting an attempted activity by at least one identity associated with the at least one cluster, wherein the attempted activity is associated with the excluded at least one permission, adding the at least one excluded permission to the reduced permission policy for the at least one cluster to thereby relax the reduced permission policy for the at least one cluster. Detecting may include discovering, determining, and/or sensing, e.g., based on a notification. Detecting an attempted activity may include identifying a request by an identity (e.g., by receiving an indication thereof) to perform an activity. An activity associated with an excluded permission may include a previously permitted activity that was removed by reducing a permission policy. Relaxing a reduced permission policy may include easing or lessening one or more restrictions associated with a reduced permission policy. Adding the at least one excluded permission to the reduced permission policy to thereby relax the reduced permission policy may include inserting the excluded permission into a reduced permission policy to thereby relax the reduced permission policy.

By way of a non-limiting example, in FIGS. 3A and 3B, upon detecting an attempted activity associated with a permission removed from permission policy 300 and therefore excluded from reduced permission policy 306, the at least one processor (e.g., processor 202 of permission server 114) may add the removed permission to reduced permission policy 306 to thereby relax reduced permission policy 306.

In some embodiments, three machine-learning (ML) approaches may be used for determining a number of clusters (K) for a clustering scheme. In a first ML approach, a number of clusters (K) may be chosen according to an algorithm (e.g., a machine learning algorithm) seeking to maximize an improvement in average risk margin, minimize a value of K, enforce an improvement in average risk margin by a threshold amount, and limit a number of permission policies. For example, a constraint may be imposed to improve an average risk margin by 60% while limiting a number of permission policies to 10% of the number of identities.

In a second ML approach, at least three different candidate solutions may be used resolve a tradeoff between reducing average risk margin and a number of permission policies (e.g., a loose solution, a medium solution, and a tight solution). A loose solution (e.g., having a risk margin below an upper threshold amount, for example below 80%) may be substantially easy implement and manage, incurring a relatively low management cost due to a relatively small number of policies, and may correspond to a relatively modest improvement in average risk margin. For example, a loose solution may be associated with a minimal number of permission policies for delivering an improvement in average risk margin above a low threshold amount (e.g., a 50% improvement in risk margin).

A medium solution (e.g., having a risk margin below a medium threshold amount, for example below 30%) may incur moderate management costs due to a moderately larger number of permission policies in return for a substantial improvement in average risk margin. For example, a medium solution may be associated with a minimal number of permission policies for delivering an average risk margin above a moderate threshold amount (e.g., at least a 75% improvement in average risk margin).

A tight solution (e.g., having a risk margin below a lower threshold amount, for example below 20%) may incur a substantially high management costs due to a relatively large number of permission policies in return for a significant improvement in average risk margin. A tight solution may be associated with a minimal number of permission policies for delivering an average risk margin above a high threshold amount (e.g., more than a 90% improvement in average risk margin).

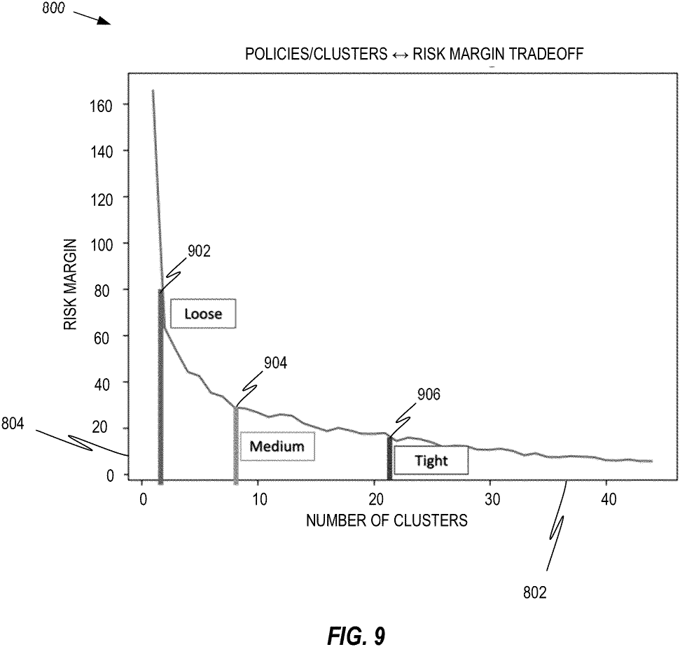

By way of a non-limiting example, reference is made to FIG. 9 illustrating exemplary chart 800 with a loose solution 902, a medium solution 904, and a tight solution 906, consistent with some embodiments of the present disclosure. Loose solution 902 may include a relatively small number of clusters (e.g., corresponding to a relatively low management cost) and a relatively high average risk margin (e.g., low efficacy). Medium solution 904 may include a moderate number of clusters (e.g., corresponding to a moderate management cost) and a moderate average risk margin (e.g., moderate efficacy). Tight solution 906 may include a relatively high number of clusters (e.g., corresponding to a relatively high management cost) and a relatively low average risk margin (e.g., high efficacy).

In a third ML approach, a constraint may be placed on a number of permission policies, corresponding to a number of clusters (K). A value for Kmay be constrained by an upper threshold amount and/or an average risk margin may be constrained by a lower threshold amount. For example, a smallest value for K may be selected to achieve a desired improvement in average risk margin. Upon selecting a value for K, a POLP permission policy may be determined for the identities in each of the K clusters.

In some embodiments, the at least one processor may perform a procedure for applying a POLP permission policy to a cluster of identities. The at least one process may select a value for K, as described earlier, and receive a mapping between each identity and one of the K clusters. For each cluster, the at least one processor may use the mapping to find the identities in each cluster. The at least one processor may merge activities for the identities in each cluster (e.g., by applying a Union operator). The at least one processor may transform the merged activities into a POLP permission policy for the cluster (e.g., stored as an electronic file using a JSON format) and assign the POLP permission policy to each identity in the cluster. The at least one processor may repeat the fully procedure according to one or more criterion, e.g., in response to a detected or suspected threat, at regular time intervals (e.g., once a month, or three time a year), upon determining a threshold increase or decrease in a number of identities, and/or based on any other criterion for updating permission policies in a cloud computing environment.

Some embodiments involve a system for managing a plurality of permission policies. The system may include at least one hardware processor configured to: collect a plurality of activities associated with each of a plurality of identities, where each identity of the plurality of identities corresponds to a permission policy, and where each activity of the plurality of activities complies with the permission policy corresponding to the associated identity; for each identity, calculating a risk margin indicating a gap between the corresponding permission policy and the associated activities; determine a plurality of candidate clustering schemes for the plurality of identities, where each candidate clustering scheme includes a plurality of distinct non-overlapping clusters corresponding to a partition of the plurality of identities based on a similarity measure of the associated activities; for at least one distinct non-overlapping cluster of at least one of the plurality of candidate clustering schemes, determine a reduced permission policy, the reduced permission policy excluding at least one permission included in the permission policy for at least one identity included in the cluster, while allowing each identity in the cluster to subsequently perform each associated activity; calculate an average risk margin for each candidate clustering scheme based on the at least one reduced permission policy for the at least one cluster; and select a specific clustering scheme from the plurality of candidate clustering schemes based on a number of clusters for each candidate clustering scheme and the average risk margin for each candidate clustering scheme.

Some embodiments involve a non-transitory computer-readable medium storing instructions that, when executed by at least one processor, are configured to cause the at least one processor to perform operations for managing a plurality of permission policies. The operations may include: collecting a plurality of activities associated with each of a plurality of identities, where each identity of the plurality of identities corresponds to a permission policy, and where each activity of the plurality of activities complies with the permission policy corresponding to the associated identity; for each identity, calculating a risk margin indicating a gap between the corresponding permission policy and the associated activities; determining a plurality of candidate clustering schemes for the plurality of identities, where each candidate clustering scheme includes a plurality of distinct non-overlapping clusters corresponding to a partition of the plurality of identities based on a similarity measure of the associated activities; for at least one distinct non-overlapping cluster of at least one of the plurality of candidate clustering schemes, determining a reduced permission policy, the reduced permission policy excluding at least one permission included in the permission policy for at least one identity included in the cluster, while allowing each identity in the cluster to subsequently perform each associated activity; calculating an average risk margin for each candidate clustering scheme based on the at least one reduced permission policy for the at least one cluster; and selecting a specific clustering scheme from the plurality of candidate clustering schemes based on a number of clusters for each candidate clustering scheme and the average risk margin for each candidate clustering scheme.

Reference is made to FIG. 3A illustrating an exemplary schematic diagram of an exemplary permission policy 300, and to FIG. 3B illustrating an exemplary schematic diagram of an exemplary reduced permission policy 306 after excluding at least one permission from the permission policy of FIG. 3A, consistent with some embodiments of the present disclosure. Permission policy 300 may be associated with activities that may be performed (e.g., permitted) by an identity. Associated activities 302 may correspond to activities that have been performed (e.g., exploited permissions) in associated with the identity. Gap 304 may correspond to a risk margin indicating a discrepancy between permission policy 300 and associated activities 302. In FIG. 3B, reduced permission policy 306 may correspond to activities that may be performed by the identity after removing one or more permissions from permission policy 300. Gap 308 may correspond to a risk margin indicating a discrepancy between reduced permission policy 306 and associated activities 302. Gap 308 may be smaller than gap 304 by a difference 310, indicating a reduction in risk margin attributable to reduced permission policy 306.

By way of a non-limiting example, in FIG. 1, at least one hardware processor (e.g., at least one processor 202 of permission server 114) may collect a plurality of activities associated with each of a plurality of identities (e.g., client devices 104), where each identity of the plurality of identities may correspond to a permission policy (e.g., permission policy 300 of FIG. 3A). For example, permission server 114 may collect the plurality of activities as one or more audit logs associated with client devices 104 from server 106. Referring to FIG. 3A, associated activities 302 may be a subset of permission policy 300. Each activity of the plurality of activities may comply with the permission policy corresponding to the associated identity. For each identity, the at least one processor may calculate a risk margin indicating a gap (e.g., gap 304) between the corresponding permission policy 300 and the associated activities 302. The at least one processor may determine a plurality of candidate clustering schemes for the plurality of identities (e.g., candidate clustering schemes 400 to 406 of FIG. 4). Each candidate clustering scheme may include a plurality of distinct non-overlapping clusters corresponding to a partition of the plurality of identities based on a similarity measure of the associated activities (e.g., clusters 412 and 414 of candidate clustering scheme 402, clusters 416, 418, and 420 of candidate clustering scheme 404, and clusters 422, 424, 426, and 428 of candidate clustering scheme 406). For at least one distinct non-overlapping cluster of at least one of the plurality of candidate clustering schemes (e.g., cluster 416 of candidate clustering scheme 404), the at least one processor may determine a reduced permission policy (e.g., reduced permission policy 306 of FIG. 3). Reduced permission policy 306 may exclude at least one permission included in permission policy 300 for identity 402 included in cluster 416, while allowing each identity in cluster 416 to subsequently perform each associated activity. For example, the at least one processor may assign reduced permission policy 306 to each identity in cluster 416. The at least one processor may calculate an average risk margin for each candidate clustering scheme based on the at least one reduced permission policy for the at least one cluster (e.g., average risk margins along y-axis 804 plotted against a number of clusters in each candidate clustering scheme along x-axis 802 in FIG. 8). The at least one processor may select a specific clustering scheme (e.g., clustering scheme 404) from plurality of candidate clustering schemes 400 to 406 based on a number of clusters for each candidate clustering scheme and the average risk margin for each candidate clustering scheme. For example, the at least one processor may calculate a tradeoff between a low average risk margin (associated with many permission policies corresponding to many clusters) and a cost for managing many permission policies. In some embodiments, the at least one processor may select a candidate clustering scheme associate with an inflection point in a graph comparing average risk margin versus a number of clusters (e.g., as a point of diminishing returns).

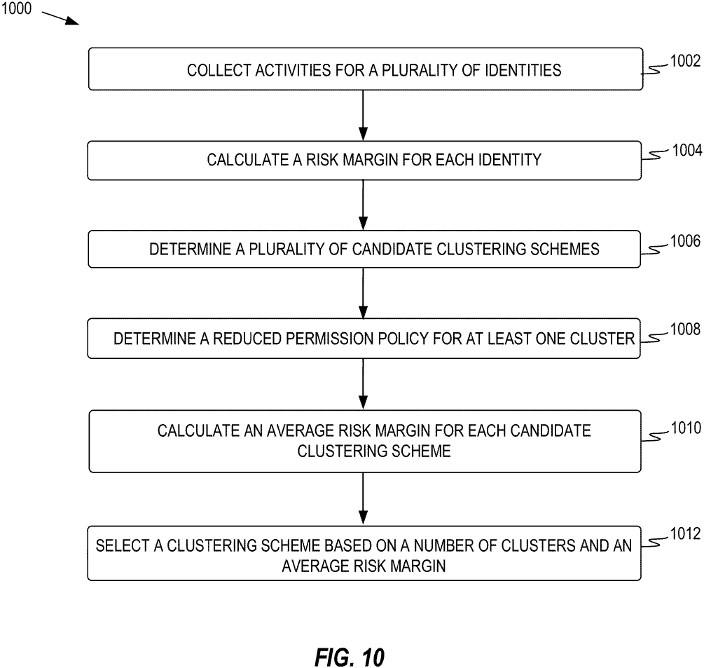

FIG. 10 illustrates a flowchart of an exemplary process 1000 for managing a plurality of permission policies, consistent with embodiments of the present disclosure. In some embodiments, process 1000 may be performed by at least one processor (e.g., at least one processor 202 of permission server 114) to perform operations or functions described herein. In some embodiments, some aspects of process 1000 may be implemented as software (e.g., program codes or instructions) that are stored in a memory (e.g., memory 204, shown in FIG. 2) or a non-transitory computer readable medium. In some embodiments, some aspects of process 1000 may be implemented as hardware (e.g., a specific-purpose circuit). In some embodiments, process 1000 may be implemented as a combination of software and hardware.

Referring to FIG. 10, process 1000 may include a step 1002 of collecting a plurality of activities associated with each of a plurality of identities, where each identity of the plurality of identities corresponds to a permission policy, and where each activity of the plurality of activities complies with the permission policy corresponding to the associated identity. By way of a non-limiting example, in FIG. 1, at least one processor 202 (FIG. 2) of permission server 114 may collect a plurality of associated activities 302 (FIG. 3A) associated with each of a plurality of identities (e.g., client devices 104), where each identity of the plurality of identities corresponds to a permission policy (e.g., permission policy 300 indicating a set of permitted activities), and where each activity of the plurality of activities complies with permission policy 300 corresponding to the associated identity.

Process 1000 may include a step 1004 of, for each identity, calculating a risk margin indicating a gap between the corresponding permission policy and the associated activities. By way of a non-limiting example, in FIG. 3 the at least one processor may calculate a risk margin (e.g., see FIG. 4 showing risk margins plotted against a number of clusters for a plurality of candidate clustering schemes) indicating a gap 304 between permission policy 300 corresponding to the identity (e.g., client device 104) and associated activities 302 collected by permission server 114.

Process 1000 may include a step 1006 of determining a plurality of candidate clustering schemes for the plurality of identities, where each candidate clustering scheme includes a plurality of distinct non-overlapping clusters corresponding to a partition of the plurality of identities based on a similarity measure of the associated activities. By way of a non-limiting example, in FIG. 4, the at least one processor may determine plurality of candidate clustering schemes 400 to 406 for a plurality of identities (e.g., indicated by identity 402). Each of candidate clustering schemes 402 to 406 may include a plurality of distinct non-overlapping clusters 412 to 428 corresponding to a partition of the plurality of identities based on a similarly measure of the associated activities. Thus, each identity in cluster 416 of candidate clustering scheme 404 may be associated with associated activities 302 for identity 402.

Process 1000 may include a step 1008 of, for at least one distinct non-overlapping cluster of at least one of the plurality of candidate clustering schemes, determining a reduced permission policy, the reduced permission policy excluding at least one permission included in the permission policy for at least one identity included in the cluster, while allowing each identity in the cluster to subsequently perform each associated activity. By way of a non-limiting example, in FIG. 3B the at least one processor may determine reduced permission policy 306 for cluster 416. Reduced permission policy 306 may exclude at least one permission included in permission policy 300 for identity 402 included in cluster 416, while allowing each identity in cluster 416 to subsequently perform each of associated activities 302.

Process 1000 may include a step 1010 of calculating an average risk margin for each candidate clustering scheme based on the at least one reduced permission policy for the at least one cluster. By way of a non-limiting example, in FIG. 8, the at least one processor may calculate an average risk margin (e.g., see average risk margins along y-axis 804) for each candidate clustering scheme (e.g., candidate clustering schemes 400 to 406) based on reduced permission policy 306 for cluster 416.

Process 1000 may include a step 1012 of selecting a specific clustering scheme from the plurality of candidate clustering schemes based on a number of clusters for each candidate clustering scheme and the average risk margin for each candidate clustering scheme. By way of a non-limiting example, in FIG. 8, the at least one processor may select a specific clustering scheme (e.g., clustering scheme 404) from plurality of candidate clustering schemes (e.g., candidate clustering schemes 400 to 406) based on a number of clusters for each candidate clustering scheme and the average risk margin for each candidate clustering scheme.

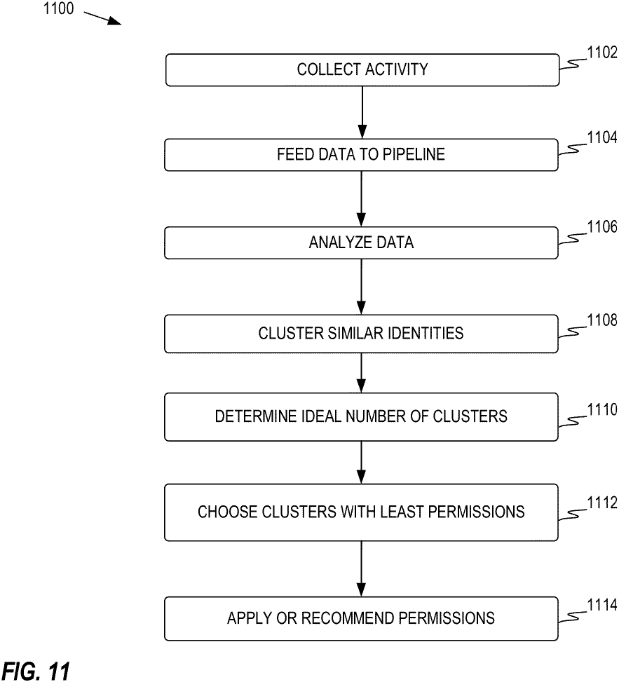

FIG. 11 is an exemplary flow diagram of another exemplary process 1100 for managing a plurality of permission policies, consistent with embodiments of the present disclosure. In some embodiments, process 1100 may be performed by at least one processor (e.g., at least one processor 202 of permission server 114) to perform operations or functions described herein. In some embodiments, some aspects of process 1100 may be implemented as software (e.g., program codes or instructions) that are stored in a memory (e.g., memory 204, shown in FIG. 2) or a non-transitory computer readable medium. In some embodiments, some aspects of process 1100 may be implemented as hardware (e.g., a specific-purpose circuit). In some embodiments, process 1100 may be implemented as a combination of software and hardware.

Referring to FIG. 11, process 1100 may include a step 1102 of collecting data associated with a plurality of activities (e.g., performed in a cloud computing environment). By way of a non-limiting example, in FIG. 1, permission server 114 may collect from at least one server 106 a plurality of activities (e.g., stored in an audit log) associated with multiple client devices 104. Process 1100 may include a step 1104 of feeding the collected data to a pipeline. Process 1100 may include a step 1106 of analyzing the data. Process 1100 may include a step 1108 of clustering similar identities. By way of a non-limiting example, in FIG. 6, permission server 114 may cluster a plurality of identities according a similarly measure of activities (e.g., clusters 602, 604, 606, and 608). Process 1100 may include a step 1110 of determining an ideal number of clusters. By way of a non-limiting example, in FIG. 8, the at least one process may determine an ideal number of clusters based on chart 800 indicating diminishing returns for increasing a number of clusters. Process 1100 may include a step 1112 of selecting clusters associated with POLP permission policies. By way of a non-limiting example, in FIGS. 3A-3B, the at least one processor may select a cluster based on reduced permission policy 306. Process 1100 may include a step 1114 of applying or recommending application of permission policies based on a selection of clusters with associated with POLP permission policies. By way of a non-limiting example, permission server 114 may store POLP permission policies in database 108 in association with one or more of client devices 104.

Audit log data may allow tracking actions of identities in a cloud computing environment. In some circumstances, transforming audit log data may allow clustering of identities based on associated actions, services, and/or resources. Such clustering may allow reducing a risk margin for an organization by identifying behavioral patterns for clusters of identities associated with similar actions. For example, clustering identities based on associated activities may allow assigning one or more POLP permission policies to one or more clusters of identities. A POLP permission may permit each identity in a cluster to subsequently perform actions conforming with recorded behavioral patterns (e.g., associated with routine roles or responsibilities), while preventing other (e.g., anomalous) actions. Moreover, applying a permission policy to an entire cluster of identities may reduce a number of permission policies that an administrator may need to enforce, thereby containing costs. Embodiments are disclosed for a method to transform audit log data to allow clustering identities according to associated actions, service, and/or resources in a cloud computing environment.

Some embodiments involve a system for determining utilized permissions in a cloud computing environment. The system may include at least one processor configured to receive authorizations granted to each identity of a plurality of identities associated with the cloud computing environment. The at least one processor may be further configured to collect a plurality of audit logs of actions performed in the cloud computing environment, the plurality of audit logs including at least: a plurality of cloud services accessed by the plurality of identities, and a plurality of actions performed on a plurality of resources associated with the plurality of cloud services. The at least one processor may be further configured to transform the plurality of audit logs to associate each specific action on each specific resource to one of the plurality of accessed services by one of the plurality of identities. The at least one processor may be further configured to generate a map mapping each identity to a plurality of objects, each object including at least one of the plurality of accessed services, at least one performed action, and at least one utilized resource. The at least one processor may be further configured to generate a report indicating at least one non-utilized authorization for at least one identity by comparing the map to the authorizations granted to each identity.

Some embodiments involve a system for determining utilized permissions in a cloud computing environment. A cloud computing environment may be understood as described earlier. A permission may include an authorization, a license, a permit, a privilege, and/or any other type of entitlement that may be granted. A permission may be stored in memory in association with an identity (e.g., in a table, an array, a record in a database, or any other structure for associating data) allowing to subsequently access the permission to determine if an action attempted by an identity is permitted. Utilized permissions may include employed and/or exploited permissions, e.g., permissions that have been used to gain one or more access privileges, for example for one more services and/or resources in a cloud computing environment. For instance, a user may be permitted to read, write, add, change, and/or delete records from five different databases. However, an audit log may indicate that the user may only perform some of the permitted actions, e.g., to access only two of the five databases, where the access operations may be limited to reading and adding records. Utilized permissions may include actions performed by (or on behalf of) a user (e.g., reading and adding records to two of the five the databases), which may be a subset of permitted actions for the user (e.g., reading, writing, adding, changing, and/or deleting records from the five databases.)

By way of a non-limiting example, in FIG. 3A taken with FIG. 1, permission policy 300 may include a plurality of permissions associated with an identity (e.g., one of client devices 104) in cloud computing environment 116. Associated activities 302 may include actions associated with the identity, as recorded in one or more audit logs. Gap 304 may indicate one or more unutilized permissions for the identity (e.g., permissions that were granted but not utilized by the user).

Some embodiments involve at least one processor configured to perform one or more operations described herein below. At least one processor may be understood as described earlier. Some embodiments involve receiving authorizations granted to each identity of a plurality of identities associated with the cloud computing environment. An identity may be understood as described earlier. In some embodiments, each identity of the plurality of identities is associated with at least one of a user, a device, a second system, or a group. A user, device, system, and group may be understood as described elsewhere in this disclosure. To grant may include to authorize, permit, and/or allow. Authorizations granted to an identity associated with a cloud computing environment may include one or more permissions and/or privileges (e.g., a permission policy) assigned to or otherwise associated with an identity, and permitting the identity to perform one or more actions in a cloud computing environment, as described elsewhere in this disclosure. Receiving may include retrieving, acquiring, or otherwise obtaining, e.g., data. Receiving may include reading data from memory and/or receiving data from a computing device via a (e.g., wired and/or wireless) communications channel. For example, at least one processor may retrieve a permission policy (e.g., as a JSON file) storing a plurality of authorizations granted to one or more identities from memory and/or receive the file from another computing device in a cloud computing environment.

By way of a non-limiting example, in FIG. 1, at least one processor (e.g., processor 202 of audit log transformer 118) may receive authorizations (e.g., permission policy 300 of FIG. 3A) granted to each identity of a plurality of identities (e.g., client devices 104) associated with cloud computing environment 116.

Some embodiments involve collecting a plurality of audit logs of activities performed in the cloud computing environment. An activity may be understood as described elsewhere in this disclosure. Audit logs of activities performed in a cloud computing environment may refer to chronological records stored in an audit trail tracing a series of activities and/or events occurring in a cloud computing environment over a period of time. Audit logs may be associated with one or more data access events, system events, administrative events, events associated with security and/or privacy violations (e.g., access deny events), differing time periods (e.g., for the same or different types of events), and/or any other category of events occurring in a cloud computing environment. At least one processor may create a plurality of audit logs based on synchronous and/or asynchronous notifications delivered from one or more event handlers in a cloud computing environment. In some embodiments, the at least one processor may create a new audit log for each received event notification, and may add each new audit log to an existing audit trail according to chronological order, e.g., based on a timestamp. An audit log may include multiple fields (e.g., columns), each field associated with a different data type. For example, an audit log may include fields for storing one or more features included in an event notification. Such fields may include, for example, an identity, a timestamp, an event type, an activity type (and/or one or more actions associated therewith), a program or command used to initiate an event, a service and/or resource associated with an event, and/or a response to an action associated with an event (e.g., an individual audit log). Upon receiving an event notification, the at least one processor may parse the received event notification to identify one or more features and store one or more of the parsed features in the corresponding field of an audit log. An audit trail of multiple audit logs may be stored in an electronic file (e.g., using Extensible Markup Language, or XML) for streaming to a memory device. In some embodiments, an activity in a cloud computing environment may be associated with a plurality of audit logs (e.g., different types of audit logs and/or recorded at different time periods). For example, a first audit log may record an action (e.g., read) performed by an identity (e.g., a user) on a file (e.g., a resource) and a second audit log may record a service (e.g., SaaS) used by an identity (e.g., the user). Thus, in some embodiments, collecting information recording an activity associated with an identity (e.g., an identity performing an action on a resource via a service) may involve collecting a plurality of (e.g., at least two) different audit logs.

Collecting may include one or more of receiving, gathering, aggregating and/or storing. At least one processor may receive a plurality of audit logs, for example, from a cloud vendor and/or one or more servers in a cloud computing environment, and store the plurality of audit logs on a memory device. In some instances, the at least one processor may collect and store a plurality of audit logs as raw (e.g., unprocessed) audit log data in a data repository of a memory device, e.g., as structured, semi-structured, and/or unstructured data, or a data lake. In some embodiments, the at least one processor may combine different audit logs associated with different resources, services, identities, and/or groups. In some embodiments, a plurality of audit logs may be collected for differing time periods (e.g., daily, weekly, monthly, or any other time period). In some embodiments, a plurality of audit logs may be collected for a period of 30 days, 60 days, 90 days, and/or more than 90 days. For example, an analytics engine may collect a plurality of audit logs for a plurality of virtual machines running simultaneously. In some embodiments, collecting a plurality of audit logs may include collecting petabytes of data.

In some embodiments, a first audit log may record a request by an identity to utilize a service (e.g., to perform an action on a resource) and a second audit log may record an action performed on a resource via the requested service. Collecting a plurality of audit logs may include combining at least the first audit log with the second audit log to allow cross-referencing common features and identify relationships there between, and which may be non-obvious and/or inaccessible by analyzing each audit log independently. In other embodiments, a single audit log may store utilizations of one or more services and actions performed in relation to one or more resources. In these embodiments, a person of ordinary skill in the art would understand that there are numerous methods to distinguish between a) utilizations of one or more services and b) actions performed in relation to one or more resources, including, for example, parsing algorithms, structured text or data, or the like.

In some embodiments, the plurality of audit logs includes audit logs acquired via processes independent from workloads associated with the activities. Acquiring may include obtaining, receiving, and/or collecting. A process may refer to an instance of a computer program executing multiple parallel threads or concurrent processes, e.g., on a single physical and/or virtual machine. Independent may refer to unrelated, uninvolved, and/or disconnected. A workload may include an application, a service, a capability, and/or a specified amount of work consuming cloud-based resources (e.g., computing or memory power). Examples of workloads may include databases, containers, microservices, or Virtual Machines. A workload associated with actions (e.g., logged actions) may refer to a work consuming cloud-based resource dedicated to performing one or more actions that may subsequently be logged. A process independent from a workload associated with the actions may include at least one processor (e.g., a physical processor and/or a virtual machine) and/or an out-of-band channel unrelated to a workload associated with performing actions that may subsequently be recorded in an audit log. For example, an independent process may be implemented with an API. An audit log acquired via processes independent from workloads associated with the activities may include an audit log obtained from one or more processes operating separately from a workload dedicated to processing event notifications for producing a plurality of audit logs. For example, a cloud computing environment may include first processes dedicated to executing workloads for performing actions and second processes dedicated to collecting and processing notifications of events recording actions to produce a plurality of audit logs. In some embodiments, the first processes and the second processes may be executed on the same physical machine. In some embodiments, the first processes and the second processes may be executed on different physical machines.

By way of a non-limiting example, in FIG. 1, at least one processor (e.g., processor 202 of audit log transformer 118) may collect a plurality of audit logs of activities performed in cloud computing environment 116.

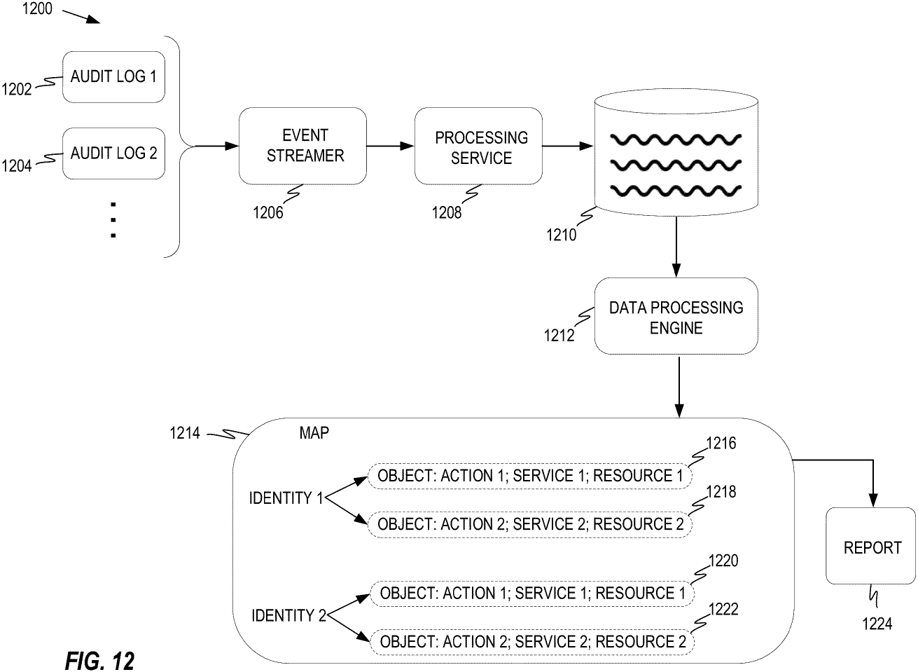

Reference is made to FIG. 12 illustrates an exemplary schematic diagram of a system 1200 for determining utilized permissions in a cloud computing environment, consistent with some embodiments of the present disclosure. System 1200 includes a plurality of audit logs 1202 and 1204, an event streamer 1206, a processing service 1208, a data repository 1210, a data processing engine 1212, a map 1214, and a report 1216. Each of audit logs 1202 and 1204 may record activities occurring in cloud computing environment 116 at a point in time. The at least one processor may receive audit logs 1202 and 1204 from at least one server 106 (e.g., associated with a vendor of cloud computing environment 116) and may collect (e.g., store) audit logs 1202 and 1204 in data repository 1210 (e.g., a data lake).

In some embodiments, the plurality of audit logs includes at least a plurality of cloud services accessed by the plurality of identities. Cloud services may include infrastructure, platforms, and/or software hosted by a providers and available via a communications network. A cloud service may facilitate a flow of data between a client (e.g., a device and/or application) and one or more resources available in a cloud computing environment. Cloud services may include Infrastructure-as-a-Service (laaS) providing one or more compute resources, networking resources, and storage resources, Software-as-a-Service (SaaS) providing applications executed on cloud infrastructure, Platform-as-a-Service (PaaS) providing information technology (IT) infrastructure for running applications, and/or Function-as-a-Service (FaaS) for developing, running, and/or managing applications in a cloud computing environment. Cloud services may additionally include data centers, operating systems, servers, database management, development tools, middleware, cloud-hosted applications, and/or infrastructures associated with data storage, networking, and/or security. Cloud services accessed by a plurality of identities may include cloud services invoked or otherwise utilized by or on behalf of a plurality of identities.

In some embodiments, the plurality of audit logs includes at least a plurality of actions performed on a plurality of resources associated with the plurality of cloud services. Actions in a cloud computing environment (e.g., actions) may include operations (e.g., executed computer program code instructions) performed in relation to a collection of distributed (e.g., hardware and/or software) compute resources via a communications network (e.g., online actions). Actions may include reading, writing, modifying, editing, uploading, downloading, sharing, deleting, restoring, archiving, encoding, encrypting, compressing, extracting, transmitting, receiving, streaming, buffering, and/or performing any other operation associated with data in a cloud computing environment. Actions may additionally include one or more backup, redundancy, and/or recovery operations. Actions may additionally include using one or more software applications in a cloud computing environment (e.g., messaging, email, data storage, word processing, spread sheet, social media applications, software testing and development, and/or any other cloud computing application). Actions may further include invoking one or more application programming interfaces (APIs) to access data and/or use one or more software application. Actions may further include performing one or more data analytics (e.g., big data) procedures on data stored in a cloud computing environment, such as querying, parsing, merging, extracting, combining, clustering, big data processing, performing one or more statistical and/or artificial intelligence (e.g., deep learning, machine learning) operations.

In some embodiments, actions may include at least one of accessing, modifying, reading, writing, or deleting data. Accessing data may include performing at least one of identifying a location where data is stored and receiving authorization to read from a data location. Accessing data may additionally include retrieving, modifying, copying, and/or moving data on a computer-readable medium. Modifying data may include at least one of editing, changing, encoding, converting, and/or transforming data stored on a computer-readable medium. Reading data may include at least one of obtaining, consuming, receiving, and/or acquiring data from a computer-readable medium. Writing data may include at least one of adding, inserting, amending, and/or otherwise embedding digitally encoded information on a computer-readable medium. Deleting data may include erasing, removing, and/or destroying information stored on a computer-readable medium.

A Resource in a cloud computing environment may be understood as described elsewhere in this disclosure. An action on a resources associated with a cloud service may include a performance of one or more operations that may result in accessing a resource via a cloud service. For example, multiple identities may use a SaaS service to simultaneously edit a single document stored in a data repository (e.g., a resource). Similarly, multiple identities may use an laaS database service to simultaneously access a group of documents stored in a cloud database.

By way of a non-limiting example, in FIG. 1 taken with FIG. 12, at least one processor (e.g., processor 202 of at least one server 106) may record a service accessed by an identity via communications network 102 in audit log 1202. For instance, audit log 1202 may record a request by one of client devices 104 to use an laaS service of cloud computing environment 116 at a first time instance. Audit log 1204 may record the one of client devices 104 reading from database 108 using the laaS service at a second time following the first time instance.

Some embodiments involve transforming the plurality of audit logs to associate each specific action on each specific resource to one of the plurality of accessed services by one of the plurality of identities. Transforming may include converting, rearranging, organizing, formatting, and/or performing any other operation to modify data. To associate may include to establish a relationship, connection, correspondence, and/or mapping between at least two elements. Associating each specific action on each specific resource to one of the plurality of accessed services by one of the plurality of identities may include establishing a relationship between a particular action (e.g., particular type of action) on a particular instance of a resource with a particular type of service by a particular identity. Transforming a plurality of audit logs to associate each specific action on each specific resource to one of the plurality of accessed services by one of the plurality of identities may include at least one processor extracting (e.g., parsing) one or more data items or features (e.g., identities, actions, resources, services, and/or any other feature of an audit log) from a plurality of audit logs, establishing one or more relationships between one or more features extracted from one or more audit logs, and reorganizing extracted features in an action schema tracing each identity to one or more associated actions, services, and/or resources, thereby associating each specific action on each specific resource to one of the plurality of accessed services by one of the plurality of identities. An action schema may include one or more relationships (e.g., new or augmented relationships) between features from different audit logs absent any individual audit log. For example, several audit logs may be combined or stitched to obtain an augmented action schema for an activity in a cloud computing environment. For instance, a first audit log may record a user requesting a service and a second audit log (recorded after the first audit log) may record an action performed on a resource via the requested service. The at least one processor may stitch the first and second audit logs to create an augmented action schema for the activity. In some embodiments, the at least one processor may combine at least 10, at least 20, at least 50, or at least 100 audit logs (e.g., recorded at different time instances) to create an augmented schema tracing an activity by an identity in a cloud computing environment. An augmented activity schema may include a plurality of relationships between features extracted from a plurality of audit logs to allow identifying a specific type of activity performed on a specific type of resource using a specific type of service (e.g., performed over a time period and recorded in multiple different audit logs). This level of granularity may allow determining one or more usage patterns that may be non-obvious and/or hidden from a query based on individual audit logs.

In some embodiments, transforming a plurality of audit logs may include reorganizing the plurality of audit logs based on a different key. For example, the at least one processor may transform the plurality of audit logs sorted chronologically over a time period to a listing sorted according to identities, resources, services, and/or actions. In some embodiments, transforming a plurality of audit logs includes determining a plurality of schema, each schema tracing an activity based on a plurality of audit logs, where the plurality of audit logs includes petabytes of data.

By way of a non-limiting example, in FIG. 12, the at least one processor (e.g. processor 202 of audit log transformer 118) may transform plurality of audit logs 1202 and 1204 to associate each specific action on each specific resource (e.g., resources 110 in FIG. 1) to one of the plurality of accessed services by one of the plurality of identities (e.g., one of client devices 104).

In some embodiments, transforming the plurality of audit logs includes transmitting the plurality of audit logs to an event streaming system (e.g., event streamer 1206). Transmitting may include communicating, sending, sharing, and/or performing any other action causing a party to receive information. An event streaming system may refer to a distributed (e.g., cloud-based) system configured to receive and store a flow of events (e.g., audit log records), allowing to move a flow of data between multiple devices and/or applications. In some embodiments, the flow of events may be continuous. An event streaming system, in some embodiments, may sort incoming audit log records according to categories or topics. Examples of an event streaming system may include Apache® Kafka, Spring Cloud Data Flow®, Amazon® Kinesis Streams, and Google® Cloud Dataflow.

By way of a non-limiting example, in FIG. 4, the at least one processor (e.g., processor 202 of audit log transformer 118 of FIG. 1) may transmit a plurality of audit logs 1202 and 1204 to event streamer 1206, e.g., for conveying audit logs 1202 and 1204 to processing service 1208.

In some embodiments, transforming the plurality of audit logs further includes filtering the plurality of audit logs stored in the event streaming system using a cloud-based processing service. Filtering (e.g., data) may include sorting, organizing, grouping, extracting, clustering, and/or removing one or more non-relevant data items from a data set. A cloud based processing service may include one or more distributed applications available over a communications network configured to process large volumes (e.g., petabytes) of data. A cloud based processing service may employ one or more artificial intelligence, machine learning, data analytics, and/or statistical algorithms to detect patterns, trends, relationship, and/or correlations from large volumes of data. Examples of cloud based processing services may include Amazon® EMR, Apache® Spark, AWS® Lambda, MicroSoft® Net, and Snowflake®. A cloud based processing service may be used to organize and/or group data items included in the plurality of audit logs according to one or more criterion, such as based on an identity and/or an action. For example, at least one processor may use a cloud based processing service to filter a plurality of audit logs for grouping identities according to associated actions, thereby transforming the plurality of audit logs from a time series of events to a series of identities associated with one or more of events. In some embodiments, filtering the plurality of audit logs is based on a subset of the plurality of identities. A subset may include at least portion of a set. In some embodiments, a subset may include and exclude at least one element of a set. In some embodiments, identities associated with events recorded in an audit log may be fewer than the total number of identities authorized to operate in a cloud computing environment such that only a subset of the plurality of identities may be associated with a plurality of audit logs over a time period.

For example, at least one processor may fetch new audit logs from a memory receptacle (e.g., a bucket) and send the new audit logs to an event streaming system (e.g., a Kafka queue). The at least one processor may use a cloud based processing service (e.g., EMR and/or Apache Spark) to perform a filtering procedure on the plurality of audit logs stored in the event streaming system (e.g., as a plurality of JSON objects) data based on a relevance measure for one or more events and/or fields included therein. The at least one processor may store filtered events and/or fields in a table stored in a data repository (e.g., a data lake), where each row of the table may correspond to a single audit log event. In some embodiments, the at least one processor may perform a second filtering procedure using a cloud based processing service (e.g., a second Spark job) to extract data items associated with a timestamp, service, action, and/or resource associated with (e.g., performed by) each identity from the audit log events stored in the data repository. In some embodiments the at least one processor may perform a third filtering procedure using a cloud based processing service (e.g., an additional Spark job) to convert the extracted data items to a data structure configured to allow clustering based on a similarity measure (e.g., of actions).

In some embodiments, the plurality of audit logs includes a real-time stream of data, and wherein the collecting, and transforming operations are performed on a continual basis. Real-time may refer to substantially instantaneously. Real-time may include unavoidable latencies (e.g., including communication and/or processing latencies associated with asynchronous communication protocols) and may exclude unavoidable latencies (e.g., associated with synchronous communication protocols). A stream of data may include a continuous sequence or flow of digitally encoded signals. A continual basis may refer to an uninterrupted, unbroken, and/or a continuous manner. For example, a server in a cloud computing environment may transmit audit log data (e.g., to a permission server) in a continuous, uninterrupted fashion as the audit log data is recorded, e.g., without introducing delays beyond communication, processing, and other unavoidable latencies.

By way of a non-limiting example, in FIG. 12, at least one processor (e.g., processor 202 of audit log transformer 118) may cause audit logs 1202 and 1204 to be streamed from at least one server 106 to event streamer 1206 (e.g., as real-time streams of data). The at least one processor may filter audit logs 1202 and 1204 using processing service 1208 (e.g., using one or more data analytics and/or clustering engines, such as Apache® Spark and/or Amazon® EMR). The at least one processor may collect filtered audit logs 1202 and 1204 in data repository 1210. In some embodiments, the at least one processor may collect and transform audit logs 1202 and 1204 on a continual basis.

Some embodiments involve generating a map mapping each identity to a plurality of objects, each object including at least one of the plurality of accessed services, at least one performed action, and at least one utilized resource. Generating may include producing, creating, and/or building. A map (e.g., a mapping) may include a graph or correspondence indicating and/or defining relationships and/or associations between multiple elements. A map may be one-directional (e.g., to indicate a one-way correspondence such as a hierarchical map) or bi-directional (e.g., to indicate a two-way or mutual correspondence). A map may be implemented as a linked list, an array, an object, a matrix, a graph, a (e.g., relational, semantic, or ontological) database, and/or any other structure for storing relationships between data items. An object may refer to a container including multiple elements (e.g., including other objects). An object may be structured such that elements contained therein may conform to a specific format or hierarchy, e.g., indicating one or more associations. Generating a map mapping each identity to a plurality of objects may include producing a collection of relationships associating each identity of the plurality of identities with at least one object (e.g., thereby producing a collection of one-to-many relationships between each identity and one or more objects). Each object may include at least one or more of an action, a service, and/or a resource accessed and/or utilized by the identity associated therewith. In some embodiments, a map may include at least one relationship associating each action, each resource, and/or each service recorded in the plurality of collected audit logs with at least one identity of the plurality of identities. In some embodiment, the map may enable clustering a plurality of identities based on a similarity measurement of associated activities.

In some embodiments, generating a map mapping each identity to a plurality of objects includes combining a plurality of audit logs (e.g., including petabytes of data), extracting a plurality of features from each audit log, and cross referencing differing extracted features from different audit logs. The map may include a plurality of relationships (e.g., augmented relationships) between different audit logs that may be absent from individual audit logs received from in an audit trail. The plurality of augmented relationships may allow clustering identities based on a similarity measure of activities, where the similarity measure may be evident from the augmented relationships.

In some embodiments, mapping a first identity of the plurality of identities to the plurality of objects includes identifying an Application Programming Interface (API) used by the first identity in association with one of the accessed services. An Application Programming Interface (API) may include a software intermediary, allowing two computing devices and/or software applications to communicate (e.g., interface) with each other (e.g., according to one or more communication standards such as HyperText Transfer Protocol, or HTTP, and/or Representational State Transfer, or REST). APIs may be available for specific programming languages, software libraries, computer operating systems, and computer hardware. An API may provide a messenger service to access one or more resources and/or services in a cloud computing environment. For example, at least one processor may invoke an API to request data from a remote database on behalf of an identity. Identifying may include recognizing and/or establishing an association with something known. Identifying an API used by an identity in association with an accessed service may include at least one processor parsing an audit log record associated with an accessed service, comparing one or more parsed portions to a collection of APIs, and determining a match to thereby identify an API invocation by an identity to access a service. In some embodiments, the API is configured to perform a specific action on a specific resource. A specific action on a specific resource may refer to a particular type of action on a particular instance of a resource. Some specific services and/or resources in a cloud computing environment may be accessible via one or more specific (e.g., custom) APIs. Associating each specific action on each specific resource to one of the plurality of accessed services by one of the plurality of identities may thus be facilitated by identifying one or more API invocations associated with one or more specific identities.

Some embodiments involve, for each activity performed within a timeframe, creating a data structure including at least an action, an associated service, an associated resource, and an associated identity, thereby creating the map. A timeframe may refer to a delimited period of time, e.g., an hour, a day, a week, a month, and/or any other delimited period of time. A data structure may include any of the examples described earlier, including but not limited to an arrangement of data items conforming to a particular organization and/or hierarchy. Types of data structures may include tables, arrays, matrices and/or objects (e.g., including multiple fields for storing differing types of data), classes, graphs (e.g., one-directional and/or bi-directional graphs), hierarchies, trees, and/or any other arrangement for organizing data items. A data structure may be replicated to create multiple instances (e.g., containers) for storing information according to a consistent organization, format, and/or hierarchy. Creating a data structure may include defining a data structure and/or allocating memory according to a data structure to allow storing data organized in a manner conforming to the data structure. A data structure including an action, an associated service, an associated resource, and an associated identity may include a declaration, definition, and/or an instantiation to allocate memory for storing an action in association with a service, a resource, and an identity according to a specific arrangement (e.g., structure). Such a data structure may establish a relationship between each identity recorded in a plurality of audit logs and one or more associated services, resources, and/or actions, to create the map. For example, the data structure may include a table, an array, and/or a matrix., and may be configured for querying.

In some embodiments, creating the data structure includes cleaning the plurality of audit logs and organizing the plurality of audit logs for uniformity in preparation for clustering based on a similarity measure. Cleaning (e.g., raw) audit log data may include, for example, removing null values, and/or normalizing data values. Organizing a plurality of audit logs for uniformity may include formatting, e.g., by adding and/or removing fields and/or columns of a data structure to ensure a uniform data structure for storing each data item included in the plurality of audit logs. Clustering may be understood as described elsewhere in this disclosure. A similarly measure may be understood as described elsewhere in this disclosure. To prepare (e.g., in preparation) may include to arrange and/or to get ready for a subsequent event. The at least one processor may format the plurality of audit logs by cleaning the data included therein and ensuring a uniform data structure to enable subsequently clustering the audit log data according to a similarity measure, e.g., based on actions associated with each identity. For example, such clustering may facilitate managing permissions for a plurality of identities, as described elsewhere in this disclosure.

In some embodiments, the map includes a multi-dimensional vector for each identity, wherein each of the accessed service, the at least one performed action, and the at least one utilized resource correspond to a different dimension of the multi-dimensional vector. A dimension may include a set (e.g., including an infinite set) of values for characterizing an object. A vector may refer to a structure including at least two dimensions for characterizing at least two separate (e.g., unrelated) aspects of an object. A multi-dimensional vector may refer to a structure including at least three dimensions for characterizing at least three separate (e.g., unrelated) aspects of an object. For example, each object (e.g., associated with each identity) may include a first dimension for storing an identity, a second dimension for storing an accessed service, a third dimension for storing an associated action, and a fourth dimension for storing a utilized resource. In some embodiments, each object may include a fifth dimension for storing an associated time stamp.

In some embodiments, transforming the plurality of audit logs includes building a directed acyclic graph. A directed acyclic graph (DAG) may refer to a directed graph (e.g., including only one-way relationships and excluding two-way relationships) lacking a cycles (e.g. loops). A DAG may describe a chronological series of tasks to be executed according to a specific order, with each subsequent task depending on a successful completion of a prior task. At least one processor may use a DAG to represent a series of interdependent tasks to simplify repeated performances of the series in a reliable manner. In data processing, a DAG may describe a pipeline of tasks for ingesting, transforming, and loading data into a database or data warehouse. For example, a DAG might include tasks for downloading data from an external API, parsing data into a structured format, and loading structured data into a database. At least one processor may use a DAG to automate a task pipeline and ensure correct execution and handling errors to avoid systemic failure. A DAG may be used to delineate a sequence of procedures for ingesting raw audit logs, processing audit logs to calculate features, clustering extracted features, and outputting a clustering result.

By way of a non-limiting example, in FIG. 12, the at least one processor (e.g., processor 202 of audit log transformer 118) may generate map 1214 mapping a first identity (e.g., associated with a fist one of client devices 104) to object 1216 and object 1218, and a second identity (e.g., associated with a second one of client devices 104) to an object 1220 and an object 1222. Objects 1216 to 1222 may each include one or more accessed services, actions, and resources (e.g., corresponding to resources 110). In some embodiments, the at least one processor may use map 1214 to cluster a plurality of identities based on a similarity measure of associated activities. For example, the at least one processor may include the first and second identities in the same cluster based on a similarity measure of activities (e.g., actions) included in objects 1216 to 1222 associated therewith. In some embodiments, the at least one processor may identify in audit log 1202 an API invocation for performing a query on database 108 (e.g., a specific action on a specific resource) by the first identity and may include an action, resource, and service associated with the API invocation, e.g., in object 1216.

In some embodiments, the at least one processor may perform one or more large scale data processing procedures on audit logs 1202 and 1204 using data processing engine 1212. For example, data processing engine 1212 may include at least one analytics engine (e.g., Tableau®, Amazon® Athena, Apache® Spark, Amazon® EMR, and/or Trino®), a machine learning engine (e.g., Amazon® SageMaker), a stream and/or batch processing engine (e.g., Flink®), business intelligence engine (e.g., Looker®), business analytics service (e.g., Power BI®), and/or a data build tool. Data processing engine 1212 may identify and/or establish a plurality of augmented relationships between audit logs 1202 and 1204 stored in data repository 1210 as unrelated audit logs. Data processing engine 1212 may use the augmented relationships to create an augmented activity schema for an activity in cloud computing environment 116, based on plurality of audit logs 1202 and 1204. Data processing engine 1212 may include the augmented relationships in mapping 1214.

In some embodiments, the at least one processor may sort audit log collected over a time period according to an identity associated therewith. The at least one processor may cross-reference at least some audit logs collected for an identity across one or more features (e.g., as keys). For instance audit log 1202 may record a request to access a service and audit log 1204 may record an action performed on a resource using the requested service. Data processing engine 1212 may cross reference audit logs 1202 and 1204 to build an augmented action schema (e.g., objects 1216 to 1222) for including in mapping 1214. The at least one processor may use objects 1216 to 1222 to cluster one or more identities based on a similarity measure of activities. In some instances, the at least one processor may apply a unique operator to the identified activities such that each activity may be listed once. In some embodiments, the at least one processor may include a frequency for each performed identity

In some embodiments, for each activity performed within a timeframe, the at least one processor may create a data structure (e.g., objects 1216, 1218, 1220, and 1222) including at least an action, an associated service, and an associated resource for each identity. Objects 1216 to 1222 of map 1214 may be multidimensional vectors associated with the first identity and the second identity, where each accessed service, action, and utilized resource may correspond to a different dimension. In some embodiments, the at least one processor may remove one or more null values from audit logs 1202 and 1204 and may organize audit logs 1202 and 1204 for uniformity to include the same number of columns in preparation for clustering. For example, the clustering may be based on a similarity measure of actions. In the example, shown, each of the first and second identities may be associated with the same actions, services, and resources (e.g., actions included in objects 1216 and 1218 associated with the first identity may be similar to objects 1220 and 1222 associated with the second identity, respectively). Consequently, the first and second identities may be included in the same cluster based on a similarity measure of actions.

Some embodiments involve generating a report indicating at least one non-utilized authorization for at least one identity by comparing the map to the authorizations granted to each identity. A non-utilized authorization may include an unused or unexploited authorization granted to an identity, e.g., external to a set of utilized authorizations described earlier. A union of utilized and unutilized authorizations may cover an entire set of authorizations granted to an identity. Returning to the earlier example, a particular user granted authorizations to read, write, add, change, and/or delete records from five different databases may only utilize some of the authorizations, for example, to read and add records from two of the five databases (e.g., based on audit log data) such that some granted authorizations may be unutilized (e.g., writing, changing, and/or deleting records from the two of the five databases, and performing any permitted action on the other three databases). Comparing may include contrasting, correlating, measuring, and/or analyzing, e.g., to identify one or more distinguishing and/or similar features between two objects. Comparing a map to authorizations granted to each identity may involve, for each action, resource, and/or service associated with an identity and included in a map, searching a file (e.g., a permission policy) storing granted authorizations. Comparing the map to the authorizations granted to each identity may additionally include indicating any non-matching authorizations and determining non-utilized authorization based on non-matching authorizations. A report may include a summary, an account, an appraisal, an assessment, and/or any other conclusive analysis of data. Indicating may include presenting, describing, demonstrating, and/or illustrating. Generating a report indicating a non-utilized authorization for an identity may include summarizing and/or listing one or more of the non-matching authorizations identified by comparing the map to the authorizations granted to each identity.

By way of a non-limiting example, in FIG. 12, the at least one processor (e.g., processor 202 of audit log transformer 118) may generate report 1224 indicating at least one non-utilized authorization for the first and second identities (e.g., each associated one of client devices 104) by comparing map 1214 to the authorizations (e.g., permission policy 300) granted to each of the first and the second identity. For example, in FIG. 3A, report 1224 may correspond to a comparison between permission policy 300 and associated (e.g., performed) actions 302. Report 1224 may include at least one non-utilized authorization corresponding to gap 304.

In some embodiments, the plurality of audit logs further includes at least one systemic change. A systemic change may include an adjustment or modification affecting a plurality of layers, computing devices, infrastructures, and/or applications of a cloud computing environment. For example, changes to system configuration (e.g., system events and/or administrative events) may be recorded in an audit log via an administration setting. In some embodiments, at least one processor may record one or more events related to systemic changes in a first audit log (e.g., stored in a first memory) and one or more events related to non-systemic changes in a second audit log (e.g., stored in a second memory). Collecting a plurality of audit logs may include storing (e.g., in a data lake) at least one audit log recording events related to systemic changes and at least one audit log recording events related to non-systemic changes. In some embodiments, at least one systemic change includes at least one of changing a system configuration setting, adding a resource, or removing a resource. Changing may include modifying, adjusting, converting, and/or transforming. Changing a system configuration setting may include changing one or more parameters affecting interoperability, functionality, and/or communication between differing components in a cloud computing environment. Changing a system configuration setting may additionally include changing one or more parameters affecting privacy, security, fault tolerancing, redundancies, scalability, elasticity, and/or any other variable having a cascading effect through a cloud computing environment. Adding a resource may include incorporating a new resource to increase a number of existing resources. Adding a resource may involve acquiring a permission to add a resource, determining a memory location to store a new resource, creating a new connection (e.g., link) to a new resource, and/or granting access to one or more identities to a new resource. Removing a resource may include extracting, eliminating, and/or erasing an existing resource to decrease a number of existing resources. Removing a resource may involve acquiring a permission to remove an existing resource, determining a memory location storing an existing resource, removing an existing connection (e.g., link) to an existing resource, and/or denying access to one or more identities to an existing resource.

Some embodiments involve mapping the at least one systemic change to one of the plurality of accessed services by one of the plurality of identities, and wherein the plurality of objects includes the at least one systemic change. A systemic change to a service may include a modification to a setting affecting a version, an update, a protocol, access privileges, and/or privacy settings (e.g., authentication certificates) for a service. A systemic change to a service may additionally include a modification to a setting affecting integration of a service with other services and/or resources, and/or one or more interfaces (e.g., APIs) for a service. A systemic change to a service may recorded in an audit log recording system events and/or administrative events. Mapping a systemic change to a service accessed by an identity may include at least one processor extracting features associated with a systemic change from at least one audit log, and transforming the extracted features to include at least one relationship between an identity and a utilized service. At least one processor may generate a plurality of objects including a system change by inserting extracted features associated with a systemic change into an object associated with an identity. For example, at least one processor may identify an audit log record recording an identity adding a resource (e.g., performing a system change). The at least one processor may insert features parsed from the audit log record into an object associated with an identity in a map to thereby transform the audit log record.

By way of a non-limiting example, in FIG. 12, audit logs 1202 and 1204 may include at least one systemic change for cloud computing environment 116 corresponding to one of client devices 104 adding a resource to resources 110 using an PaaS service of cloud computing environment 116. The at least one processor may map the addition of the resource to the PaaS service accessed by the first identity, such that object 1216 may include the systemic change.

Some embodiments involve providing at least one of the transformed plurality of audit logs or the report to a permission server configured to manage authorizations for the plurality of identities. A permission server may refer to an application and/or a machine (e.g., a physical or virtual machine) configured to manage permission in a cloud computing environment. Manage authorizations for a plurality of identities may be understood as described elsewhere in this disclosure. Providing may include transmitting, sending, sharing, and/or performing any other action to cause a party to receive or acquire (e.g., data), e.g., via a communications link. In some embodiments, a first process (e.g., running on a physical and/or virtual machine) may be configured to transform a plurality of audit logs and/or generate a report indicating non-utilized authorizations based on the plurality of transformed audit logs, and a second process (e.g., running on the same or different physical and/or virtual machine) may be configured to operate a permission server for managing authorizations for a plurality of identities.

By way of a non-limiting example, in FIG. 1, the at least one processor (e.g., processor 202 of audit log transformer 118) may provide the transformed plurality of audit logs (e.g., map 1214) or report 1224 to permission server 114 configured to manage authorizations for client devices 104.

Some embodiments involve a non-transitory computer-readable medium storing instructions that, when executed by at least one processor, are configured to cause the at least one processor to perform operations for determining utilized permissions in a cloud computing environment. The operations may include receiving authorizations granted to each identity of a plurality of identities associated with the cloud computing environment; collecting a plurality of audit logs of activities performed in the cloud computing environment, the plurality of audit logs including at least; a plurality of cloud services accessed by the plurality of identities, and a plurality of actions performed on a plurality of resources associated with the plurality of cloud services; transforming the plurality of audit logs to associate each specific action on each specific resource to one of the plurality of accessed services by one of the plurality of identities; generating a map mapping each identity to a plurality of objects, each object including at least one accessed service, at least one performed action, and at least one utilized resource; and generating a report indicating at least one non-utilized authorization for at least one identity by comparing the map to the authorizations granted to each identity.

By way of a non-limiting example, in FIG. 1 taken with FIG. 12, memory 204 (e.g., of audit log transformer 118) may store instructions that, when executed by at least one processor (e.g., processor 202), may cause operations for determining utilized permissions in cloud computing environment 116 to be performed. As a result of performing the operations, the at least one processor may receive authorizations (e.g., permission policies 300) granted to a first and second identity (e.g., for client devices 104) associated with cloud computing environment 116. The at least one processor may collect audit logs 1202 and 1204 of activities performed in the cloud computing environment 116 in data repository 1210. Audit logs 1202 and 1204 may include at least a plurality of cloud services accessed by the plurality of identities, and a plurality of actions performed on resources 110 associated with the plurality of cloud services. The at least one processor may transform audit logs 1202 and 1204 to associate each specific action on each specific resource (e.g., resources 110) to one of the plurality of accessed services by one of the plurality of identities. The at least one processor may generate map 1214 mapping the first identity to objects 1216 and 1218, and mapping the second identity to objects 1220 and 1222. Each of objects 1216 to 1222 may include at least one accessed service, at least one performed action, and at least one utilized resource. The at least one processor may generate report 1224 indicating at least one non-utilized authorization (e.g., see gap 304 of FIG. 3) for the first and/or second identities by comparing map 1214 to the authorizations (e.g., permission policy 300) granted to the first and second identities.

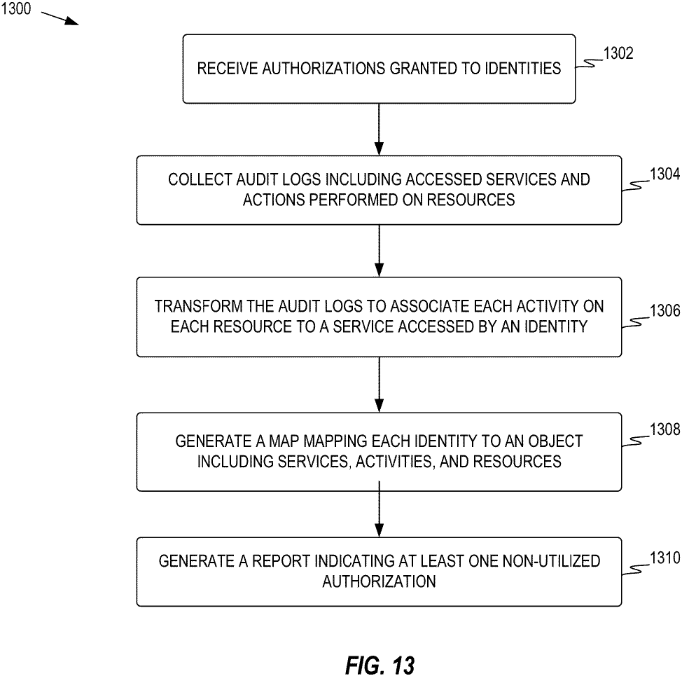

FIG. 13 is an exemplary flow diagram of an exemplary process 1300 for managing a plurality of permission policies, consistent with embodiments of the present disclosure. In some embodiments, process 1300 may be performed by at least one processor (e.g., at least one processor 202 of audit log transformer 118) to perform operations or functions described herein. In some embodiments, some aspects of process 1300 may be implemented as software (e.g., program codes or instructions) that are stored in a memory (e.g., memory 204, shown in FIG. 2) or a non-transitory computer readable medium. In some embodiments, some aspects of process 1300 may be implemented as hardware (e.g., a specific-purpose circuit). In some embodiments, process 1300 may be implemented as a combination of software and hardware.

Referring to FIG. 13, process 1300 may include a step 1302 of receiving authorizations granted to each identity of a plurality of identities associated with the cloud computing environment. By way of a non-limiting example, in FIG. 12, at least one processor (e.g., processor 202 of audit log transformer 118) may receive authorizations (e.g., permission policies 300 of FIG. 3) granted to a first and second identity (e.g., for client devices 104) associated with cloud computing environment 116.

Process 1300 may include a step 1304 of collecting a plurality of audit logs of activities performed in the cloud computing environment, the plurality of audit logs including at least: a plurality of cloud services accessed by the plurality of identities, and a plurality of actions performed on a plurality of resources associated with the plurality of cloud services. By way of a non-limiting example, in FIG. 12, the at least one processor may collect audit logs 1202 and 1204 of activities performed in the cloud computing environment 116 in data repository 1210. Audit logs 1202 and 1204 may include at least a plurality of cloud services accessed by the plurality of identities, and a plurality of actions performed on resources 110 associated with the plurality of cloud services. The at least one processor may transform audit logs 1202 and 1204 to associate each specific action on each specific resource (e.g., resources 110) to one of the plurality of accessed services by one of the plurality of identities.

Process 1300 may include a step 1306 of transforming the plurality of audit logs to associate each specific action on each specific resource to one of the plurality of accessed services by one of the plurality of identities. By way of a non-limiting example, in FIG. 12, the at least one processor may transform audit logs 1202 and 1204 to associate each specific action on each specific resource (e.g., resources 110) to one of the plurality of accessed services by one of the plurality of identities.

Process 1300 may include a step 1308 of generating a map mapping each identity to a plurality of objects, each object including at least one accessed service, at least one performed action, and at least one utilized resource. By way of a non-limiting example, in FIG. 12, the at least one processor may generate map 1214 mapping the first identity to objects 1216 and 1218, and mapping the second identity to objects 1220 and 1222. Each of objects 1216 to 1222 may include at least one accessed service, at least one performed action, and at least one utilized resource.

Process 1300 may include a step 1310 of generating a report indicating at least one non-utilized authorization for at least one identity by comparing the map to the authorizations granted to each identity. By way of a non-limiting example, in FIG. 12, the at least one processor may generate report 1224 indicating at least one non-utilized authorization (e.g., see gap 304 of FIG. 3) for the first and/or second identities by comparing map 1214 to the authorizations (e.g., permission policy 300) granted to the first and second identities.

Examples of inventive concepts are contained in the following clauses which are an integral part of this disclosure.

Clause 1. A method for managing a plurality of permission policies, the method comprising:
collecting a plurality of activities associated with each of a plurality of identities, wherein each identity of the plurality of identities corresponds to a permission policy, and wherein each activity of the plurality of activities complies with the permission policy corresponding to the associated identity;
for each identity, calculating a risk margin indicating a gap between the corresponding permission policy and the associated activities;
determining a plurality of candidate clustering schemes for the plurality of identities, wherein each candidate clustering scheme includes a plurality of distinct non-overlapping clusters corresponding to a partition of the plurality of identities based on a similarity measure of the associated activities;
for at least one distinct non-overlapping cluster of at least one of the plurality of candidate clustering schemes, determining a reduced permission policy, the reduced permission policy excluding at least one permission included in the permission policy for at least one identity included in the cluster, while allowing each identity in the cluster to subsequently perform each associated activity;
calculating an average risk margin for each candidate clustering scheme based on the at least one reduced permission policy for the at least one cluster; and
selecting a specific clustering scheme from the plurality of candidate clustering schemes based on a number of clusters for each candidate clustering scheme and the average risk margin for each candidate clustering scheme.

Clause 2. The method according to clause 1, wherein each identity is associated with at least one of a user, a device, a system, or a group.

Clause 3. The method according to any of clauses 1-2, wherein each activity includes at least one of requesting data, viewing data, editing data, adding data, deleting data, modifying data, performing a function, or causing a function to be performed.

Clause 4. The method according to any of clauses 1-3, wherein at least one associated permission policy imposes a frequency limitation on at least one of the activities.

Clause 5. The method according to any of clauses 1-4, further comprising organizing the collected plurality of activities according to services, actions, and resources, thereby associating each identity with at least one of a service, an action, or a resource.

Clause 6. The method according to any of clauses 1-5, wherein the risk margin for each identity further indicates a gap between the permission policy corresponding to the identity and the at least one services, actions, or resources associated with the identity.

Clause 7. The method according to any of clauses 1-6, wherein the at least one service is a cloud storage service.

Clause 8. The method according to any of clauses 1-7, wherein the at least one resource includes at least one of a virtual resource, a physical resource, a function providing resource, or a data storage resource.

Clause 9. The method according to any of clauses 1-8, wherein the gap is associated with at least one unutilized permission of the associated permission policy.

Clause 10. The method according to any of clauses 1-9, wherein the gap for each identity corresponds to an efficacy measure of the corresponding permission policy.

Clause 11. The method according to any of clauses 1-10, wherein determining the plurality of candidate clustering schemes includes applying at least one of a K-means clustering, an unsupervised learning clustering, a Density-Based Spatial Clustering of Applications with Noise clustering, or a hierarchical clustering to the plurality of identities.

Clause 12. The method according to any of clauses 1-11, wherein determining the plurality of candidate clustering schemes is further based on the determined associations between each activity and the at least one service, action, or resource.

Clause 13. The method according to any of clauses 1-12, wherein each candidate clustering scheme includes a differing number of distinct non-overlapping clusters.

Clause 14. The method according to any of clauses 1-13, wherein for at least one of the plurality of candidate clustering schemes, a number of distinct non-overlapping clusters included in the at least one candidate clustering scheme equals a number of permission policies.

Clause 15. The method according to any of clauses 1-14, wherein for at least one of the plurality of candidate clustering schemes, a number of distinct non-overlapping clusters included in the at least one candidate clustering scheme is less than a number of permission policies.

Clause 16. The method according to any of clauses 15, wherein selecting the specific candidate clustering scheme from the plurality of candidate clustering schemes includes ordering the plurality of candidate clustering schemes based on a number of clusters included in each candidate clustering scheme,
for at least one adjacent pair of the ordered candidate clustering schemes, calculating a change between the average risk margins for the candidate clustering scheme in the adjacent pair, and
selecting one of the candidate clustering schemes of the adjacent pair of ordered adjacent candidate clustering schemes when the change is less than a threshold change in risk margin.

Clause 17. The method according to any of clauses 1-16, further comprising applying the permission policies of the selected clustering scheme to the plurality of identities such that each identity is permitted to perform activities in compliance with the permission policy of the selected clustering scheme while being forbidden to perform activities that violate the permission policy of the selected clustering scheme.

Clause 18. The method according to any of clauses 1-17, further comprising, for at least one cluster included in the selected clustering scheme, upon detecting an attempted activity by at least one identity associated with the at least one cluster, wherein the attempted activity is associated with the excluded at least one permission, adding the at least one excluded permission to the reduced permission policy for the at least one cluster to thereby relax the reduced permission policy for the at least one cluster.

Clause 19. A system for managing a plurality of permission policies, the system comprising:
at least one hardware processor configured to:
   collect a plurality of activities associated with each of a plurality of identities, wherein each identity of the plurality of identities corresponds to a permission policy, and wherein each activity of the plurality of activities complies with the permission policy corresponding to the associated identity;
   for each identity, calculating a risk margin indicating a gap between the corresponding permission policy and the associated activities;
   determine a plurality of candidate clustering schemes for the plurality of identities, wherein each candidate clustering scheme includes a plurality of distinct non-overlapping clusters corresponding to a partition of the plurality of identities based on a similarity measure of the associated activities;
   for at least one distinct non-overlapping cluster of at least one of the plurality of candidate clustering schemes, determine a reduced permission policy, the reduced permission policy excluding at least one permission included in the permission policy for at least one identity included in the cluster, while allowing each identity in the cluster to subsequently perform each associated activity;
   calculate an average risk margin for each candidate clustering scheme based on the at least one reduced permission policy for the at least one cluster; and
   select a specific clustering scheme from the plurality of candidate clustering schemes based on a number of clusters for each candidate clustering scheme and the average risk margin for each candidate clustering scheme.

Clause 20. A non-transitory computer-readable medium storing instructions that, when executed by at least one processor, are configured to cause the at least one processor to perform operations for managing a plurality of permission policies, the operations comprising:
collecting a plurality of activities associated with each of a plurality of identities, wherein each identity of the plurality of identities corresponds to a permission policy, and wherein each activity of the plurality of activities complies with the permission policy corresponding to the associated identity;
for each identity, calculating a risk margin indicating a gap between the corresponding permission policy and the associated activities;
determining a plurality of candidate clustering schemes for the plurality of identities, wherein each candidate clustering scheme includes a plurality of distinct non-overlapping clusters corresponding to a partition of the plurality of identities based on a similarity measure of the associated activities;
for at least one distinct non-overlapping cluster of at least one of the plurality of candidate clustering schemes, determining a reduced permission policy, the reduced permission policy excluding at least one permission included in the permission policy for at least one identity included in the cluster, while allowing each identity in the cluster to subsequently perform each associated activity;
calculating an average risk margin for each candidate clustering scheme based on the at least one reduced permission policy for the at least one cluster; and
selecting a specific clustering scheme from the plurality of candidate clustering schemes based on a number of clusters for each candidate clustering scheme and the average risk margin for each candidate clustering scheme.

Clause 21. A system for determining utilized permissions in a cloud computing environment, the system comprising:
at least one processor configured to:
   receive authorizations granted to each identity of a plurality of identities associated with the cloud computing environment;
   collect a plurality of audit logs of activities performed in the cloud computing environment, the plurality of audit logs including at least:
      a plurality of cloud services accessed by the plurality of identities, and
      a plurality of actions performed on a plurality of resources associated with the plurality of cloud services;
   transform the plurality of audit logs to associate each specific action on each specific resource to one of the plurality of accessed services by one of the plurality of identities;
   generate a map mapping each identity to a plurality of objects, each object including at least one of the plurality of accessed services, at least one performed action, and at least one utilized resource; and
   generate a report indicating at least one non-utilized authorization for at least one identity by comparing the map to the authorizations granted to each identity.

Clause 22. The system according to any of clauses 1-21, wherein the plurality of audit logs includes audit logs acquired via processes independent from workloads associated with the activities.

Clause 23. The system according to any of clauses 1-22, wherein each identity of the plurality of identities is associated with at least one of a user, a device, a second system, or a group.

Clause 24. The system according to any of clauses 1-23, wherein the plurality of actions includes at least one of accessing, modifying, reading, writing, or deleting data.

Clause 25. The system according to any of clauses 1-24, wherein mapping a first identity of the plurality of identities to the plurality of objects includes identifying an Application Programming Interface (API) used by the first identity in association with one of the accessed services.

Clause 26. The system according to any of clauses 1-25, wherein the API is configured to perform a specific action on a specific resource.

Clause 27. The system according to any of clauses 1-26, wherein the plurality of audit logs includes a real-time stream of data, and wherein the collecting, and transforming operations are performed on a continual basis.

Clause 28. The system according to any of clauses 1-27, wherein transforming the plurality of audit logs includes transmitting the plurality of audit logs to an event streaming system.

Clause 29. The system according to any of clauses 1-28, wherein transforming the plurality of audit logs further includes filtering the plurality of audit logs stored in the event streaming system using a cloud-based processing service

Clause 30. The system according to any of clauses 1-29, wherein filtering the plurality of audit logs is based on a subset of the plurality of identities.

Clause 31. The system according to any of clauses 1-30, further comprising, for each activity performed within a timeframe, creating a data structure including at least an action, an associated service, an associated resource, and an associated identity, thereby creating the map.

Clause 32. The system according to any of clauses 1-31, wherein creating the data structure includes cleaning the plurality of audit logs and organizing the plurality of audit logs for uniformity in preparation for clustering based on a similarity measure.

Clause 33. The system according to any of clauses 1-32, wherein the map includes a multi-dimensional vector for each identity, wherein each of the accessed service, the at least one performed action, and the at least one utilized resource correspond to a different dimension of the multi-dimensional vector.

Clause 34. The system according to any of clauses 1-33, wherein transforming the plurality of audit logs includes building a directed acyclic graph.

Clause 35. The system according to any of clauses 1-34, wherein the plurality of audit logs further includes at least one systemic change.

Clause 36. The system according to any of clauses 1-35, wherein the at least one systemic change includes at least one of changing a system configuration setting, adding a resource, or removing a resource.

Clause 37. The system according to any of clauses 1-36, wherein transforming the plurality of audit logs further includes mapping the at least one systemic change to one of the plurality of accessed services by one of the plurality of identities, and wherein the plurality of objects includes the at least one systemic change.

Clause 38. The system according to any of clauses 1-37, wherein the at least one processor is further configured to provide at least one of the transformed plurality of audit logs or the report to a permission server configured to manage authorizations for the plurality of identities.

Clause 39. A method for determining utilized permissions in a cloud computing environment, the method comprising:
receiving authorizations granted to each identity of a plurality of identities associated with in the cloud computing environment;
collecting a plurality of audit logs of activities performed in the cloud computing environment, the plurality of audit logs including at least:
a plurality of cloud services accessed by the plurality of identities, and
a plurality of actions performed on a plurality of resources associated with the plurality of cloud services; and
transforming the plurality of audit logs to associate each specific action on each specific resource to one of the plurality of accessed services by one of the plurality of identities;
generate a map mapping each identity to a plurality of objects, each object including at least one accessed service, at least one performed action, and at least one utilized resource;
generate a report indicating at least one non-utilized authorization for at least one identity by comparing the map to the authorizations granted to each identity.

Clause 40. A non-transitory computer-readable medium storing instructions that, when executed by at least one processor, are configured to cause the at least one processor to perform operations for determining utilized permissions in a cloud computing environment, the operations comprising:
receiving authorizations granted to each identity of a plurality of identities associated with the cloud computing environment;
collecting a plurality of audit logs of activities performed in the cloud computing environment, the plurality of audit logs including at least:
a plurality of cloud services accessed by the plurality of identities, and
a plurality of actions performed on a plurality of resources associated with the plurality of cloud services;
transforming the plurality of audit logs to associate each specific action on each specific resource to one of the plurality of accessed services by one of the plurality of identities;
generating a map mapping each identity to a plurality of objects, each object including at least one accessed service, at least one performed action, and at least one utilized resource; and generating a report indicating at least one non-utilized authorization for at least one identity by comparing the map to the authorizations granted to each identity.

Disclosed embodiments may include any one of the following bullet-pointed features alone or in combination with one or more other bullet-pointed features, whether implemented as a system and/or method, by at least one processor or circuitry, and/or stored as executable instructions on non-transitory computer readable media or computer readable media.
A method for managing a plurality of permission policies;
collecting a plurality of activities associated with each of a plurality of identities;
each identity of a plurality of identities corresponds to a permission policy;
each activity of a plurality of activities complies with a permission policy corresponding to an associated identity;
for each identity, calculating a risk margin;
a risk margin indicating a gap between a corresponding permission policy and an associated activities;
determining a plurality of candidate clustering schemes for a plurality of identities;
each candidate clustering scheme includes a plurality of distinct non-overlapping clusters corresponding to a partition of a plurality of identities based on a similarity measure of associated activities;
for at least one distinct non-overlapping cluster of at least one of a plurality of candidate clustering schemes, determining a reduced permission policy;
a reduced permission policy excluding at least one permission included in a permission policy for at least one identity included in a cluster;
a reduced permission policy allowing each identity in a cluster to subsequently perform each associated activity;
calculating an average risk margin for each candidate clustering scheme based on at least one reduced permission policy for at least one cluster;
selecting a specific clustering scheme from a plurality of candidate clustering schemes based on a number of clusters for each candidate clustering scheme and an average risk margin for each candidate clustering scheme.
each identity associated with at least one of a user, a device, a system, or a group;
each activity including at least one of requesting data, viewing data, editing data, adding data, deleting data, modifying data, performing a function, or causing a function to be performed;
at least one associated permission policy imposing a frequency limitation on at least one activity.
organizing a collected plurality of activities according to services, actions, and resources;
associating each identity with at least one of a service, an action, or a resource;
a risk margin for each identity further indicating a gap between a permission policy corresponding to an identity and at least one service, action, or resource associated with an identity;
at least one service is a cloud storage service;
at least one resource including at least one of a virtual resource, a physical resource, a function providing resource, or a data storage resource;
a gap associated with at least one unutilized permission of an associated permission policy;
a gap for each identity corresponding to an efficacy measure of a corresponding permission policy;
applying at least one of a K-means clustering, an unsupervised learning clustering, a Density-Based Spatial Clustering of Applications with Noise clustering, or a hierarchical clustering to the plurality of identities;
determining a plurality of candidate clustering schemes based on determined associations between each activity and at least one service, action, or resource;
each candidate clustering scheme including a differing number of distinct non-overlapping clusters;
for at least one of a plurality of candidate clustering schemes, a number of distinct non-overlapping clusters included in the at least one candidate clustering scheme equal to a number of permission policies;
for at least one of a plurality of candidate clustering schemes, a number of distinct non-overlapping clusters included in the at least one candidate clustering scheme is less than a number of permission policies;
ordering the plurality of candidate clustering schemes based on a number of clusters included in each candidate clustering scheme;
for at least one adjacent pair of an ordered candidate clustering scheme, calculating a change between an average risk margins for a candidate clustering scheme in an adjacent pair;
selecting a candidate clustering scheme of an adjacent pair of ordered adjacent candidate clustering schemes when a change is less than a threshold change in risk margin;
applying permission policies of a selected clustering scheme to a plurality of identities such that each identity is permitted to perform activities in compliance with the permission policy of a selected clustering scheme while being forbidden to perform activities that violate a permission policy of a selected clustering scheme;
for at least one cluster included in a selected clustering scheme, detecting an attempted activity by at least one identity associated with the at least one cluster;
an attempted activity associated with an excluded at least one permission;
adding at least one excluded permission to a reduced permission policy for at least one cluster;
relaxing a reduced permission policy for at least one cluster;
a system for managing a plurality of permission policies;
at least one hardware processor configured to collect a plurality of activities associated with each of a plurality of identities;
each identity of a plurality of identities corresponding to a permission policy;
each activity of a plurality of activities complying with a permission policy corresponding to an associated identity;
at least one hardware processor configured to, for each identity, calculate a risk margin indicating a gap between a corresponding permission policy and an associated activities;
at least one hardware processor configured to determine a plurality of candidate clustering schemes for a plurality of identities;
each candidate clustering scheme including a plurality of distinct non-overlapping clusters corresponding to a partition of a plurality of identities based on a similarity measure of the associated activities;
for at least one distinct non-overlapping cluster of at least one of the plurality of candidate clustering schemes, at least one hardware processor configured to determine a reduced permission policy;
a reduced permission policy excluding at least one permission included in a permission policy for at least one identity included in a cluster;
a reduced permission policy allowing each identity in a cluster to subsequently perform each associated activity;
at least one hardware processor configured to calculate an average risk margin for each candidate clustering scheme based on at least one reduced permission policy for at least one cluster;
at least one hardware processor configured to select a specific clustering scheme from a plurality of candidate clustering schemes based on a number of clusters for each candidate clustering scheme and an average risk margin for each candidate clustering scheme;
a system for determining utilized permissions in a cloud computing environment;
at least one processor configured to receive authorizations;
authorizations granted to each identity of a plurality of identities associated with a cloud computing environment;
at least one processor configured to collect a plurality of audit logs of activities performed in a cloud computing environment;
a plurality of audit logs including at least: a plurality of cloud services accessed by the plurality of identities;
a plurality of audit logs including at least: a plurality of actions performed on a plurality of resources associated with the plurality of cloud services;
at least one processor configured to transform a plurality of audit logs to associate each specific action on each specific resource to one of a plurality of accessed services by one of a plurality of identities;
at least one processor configured to generate a map mapping each identity to a plurality of objects;
each object including at least one of a plurality of accessed services, at least one performed action, and at least one utilized resource;
at least one processor configured to generate a report indicating at least one non-utilized authorization for at least one identity;
at least one processor configured to compare a map to authorizations granted to each identity;
a plurality of audit logs including audit logs acquired via processes independent from workloads associated with activities;
each identity of a plurality of identities associated with at least one of a user, a device, a second system, or a group;
a plurality of actions including at least one of accessing, modifying, reading, writing, or deleting data;
identifying an Application Programming Interface (API) used by a first identity in association with an accessed service.
an API is configured to perform a specific action on a specific resource;
a plurality of audit logs including a real-time stream of data;
performing collecting, and transforming operations on a continual basis;
transmitting a plurality of audit logs to an event streaming system;
filtering a plurality of audit logs stored in an event streaming system using a cloud-based processing service;
filtering a plurality of audit logs based on a subset of a plurality of identities;
for each activity performed within a timeframe, creating a data structure including at least an action, an associated service, an associated resource, and an associated identity, thereby creating a map;
cleaning a plurality of audit logs and organizing a plurality of audit logs for uniformity in preparation for clustering based on a similarity measure;
a map including a multi-dimensional vector for each identity;
each of an accessed service, an at least one performed action, and an at least one utilized resource corresponding to a different dimension of a multi-dimensional vector;
transforming a plurality of audit logs including building a directed acyclic graph;
a plurality of audit logs further including at least one systemic change;
a systemic change including at least one of changing a system configuration setting, adding a resource, or removing a resource;
mapping at least one systemic change to one of a plurality of accessed services by one of a plurality of identities;
a plurality of objects including at least one systemic change;
at least one processor configured to provide at least one of a transformed plurality of audit logs or a report to a permission server;
a permission server configured to manage authorizations for a plurality of identities.

1. A method for managing a plurality of permission policies, the method comprising:
collecting a plurality of activities associated with each of a plurality of identities, wherein each identity of the plurality of identities corresponds to a permission policy, and wherein each activity of the plurality of activities complies with the permission policy corresponding to the associated identity;
for each identity, calculating a risk margin indicating a gap between the corresponding permission policy and the associated activities;
determining a plurality of candidate clustering schemes for the plurality of identities, wherein each candidate clustering scheme includes a plurality of distinct non-overlapping clusters corresponding to a partition of the plurality of identities based on a similarity measure of the associated activities;
for at least one distinct non-overlapping cluster of at least one of the plurality of candidate clustering schemes, determining a reduced permission policy, the reduced permission policy excluding at least one permission included in the permission policy for at least one identity included in the cluster, while allowing each identity in the cluster to subsequently perform each associated activity;
calculating an average risk margin for each candidate clustering scheme based on the at least one reduced permission policy for the at least one cluster; and
selecting a specific clustering scheme from the plurality of candidate clustering schemes based on a number of clusters for each candidate clustering scheme and the average risk margin for each candidate clustering scheme.

2. The method of claim 1, wherein each identity is associated with at least one of a user, a device, a system, or a group.

3. The method of claim 1, wherein each activity includes at least one of requesting data, viewing data, editing data, adding data, deleting data, modifying data, performing a function, or causing a function to be performed.

4. The method of claim 1, wherein at least one associated permission policy imposes a frequency limitation on at least one of the activities.

5. The method of claim 1, further comprising organizing the collected plurality of activities according to services, actions, and resources, thereby associating each identity with at least one of a service, an action, or a resource.

6. The method of claim 5, wherein the risk margin for each identity further indicates a gap between the permission policy corresponding to the identity and the at least one services, actions, or resources associated with the identity.

7. The method of claim 5, wherein the at least one service is a cloud storage service.

8. The method of claim 5, wherein the at least one resource includes at least one of a virtual resource, a physical resource, a function providing resource, or a data storage resource.

9. The method of claim 1, wherein the gap is associated with at least one unutilized permission of the associated permission policy.

10. The method of claim 1, wherein the gap for each identity corresponds to an efficacy measure of the corresponding permission policy.

11. The method of claim 1, wherein determining the plurality of candidate clustering schemes includes applying at least one of a K-means clustering, an unsupervised learning clustering, a Density-Based Spatial Clustering of Applications with Noise clustering, or a hierarchical clustering to the plurality of identities.

12. The method of claim 5, wherein determining the plurality of candidate clustering schemes is further based on the determined associations between each activity and the at least one service, action, or resource.

13. The method of claim 1, wherein each candidate clustering scheme includes a differing number of distinct non-overlapping clusters.

14. The method of claim 1, wherein for at least one of the plurality of candidate clustering schemes, a number of distinct non-overlapping clusters included in the at least one candidate clustering scheme equals a number of permission policies.

15. The method of claim 1, wherein for at least one of the plurality of candidate clustering schemes, a number of distinct non-overlapping clusters included in the at least one candidate clustering scheme is less than a number of permission policies.

16. The method of claim 1, wherein selecting the specific candidate clustering scheme from the plurality of candidate clustering schemes includes ordering the plurality of candidate clustering scheme based on a number of clusters included in each candidate clustering scheme,
for at least one adjacent pair of the ordered candidate clustering schemes, calculating a change between the average risk margins for the candidate clustering scheme in the adjacent pair, and
selecting one of the candidate clustering schemes of the adjacent pair of ordered adjacent candidate clustering schemes when the change is less than a threshold change in risk margin.

17. The method of claim 1, further comprising applying the permission policies of the selected clustering scheme to the plurality of identities such that each identity is permitted to perform activities in compliance with the permission policy of the selected clustering scheme while being forbidden to perform activities that violate the permission policy of the selected clustering scheme.

18. The method of claim 17, further comprising, for at least one cluster included in the selected clustering scheme, upon detecting an attempted activity by at least one identity associated with the at least one cluster, wherein the attempted activity is associated with the excluded at least one permission, adding the at least one excluded permission to the reduced permission policy for the at least one cluster to thereby relax the reduced permission policy for the at least one cluster.

19. A system for managing a plurality of permission policies, the system comprising:
at least one hardware processor configured to:
collect a plurality of activities associated with each of a plurality of identities, wherein each identity of the plurality of identities corresponds to a permission policy, and wherein each activity of the plurality of activities complies with the permission policy corresponding to the associated identity;
for each identity, calculating a risk margin indicating a gap between the corresponding permission policy and the associated activities;
determine a plurality of candidate clustering schemes for the plurality of identities, wherein each candidate clustering scheme includes a plurality of distinct non-overlapping clusters corresponding to a partition of the plurality of identities based on a similarity measure of the associated activities;
for at least one distinct non-overlapping cluster of at least one of the plurality of candidate clustering schemes, determine a reduced permission policy, the reduced permission policy excluding at least one permission included in the permission policy for at least one identity included in the cluster, while allowing each identity in the cluster to subsequently perform each associated activity;
calculate an average risk margin for each candidate clustering scheme based on the at least one reduced permission policy for the at least one cluster; and
select a specific clustering scheme from the plurality of candidate clustering schemes based on a number of clusters for each candidate clustering scheme and the average risk margin for each candidate clustering scheme.

20. A non-transitory computer-readable medium storing instructions that, when executed by at least one processor, are configured to cause the at least one processor to perform operations for managing a plurality of permission policies, the operations comprising:
collecting a plurality of activities associated with each of a plurality of identities, wherein each identity of the plurality of identities corresponds to a permission policy, and wherein each activity of the plurality of activities complies with the permission policy corresponding to the associated identity;
for each identity, calculating a risk margin indicating a gap between the corresponding permission policy and the associated activities;
determining a plurality of candidate clustering schemes for the plurality of identities, wherein each candidate clustering scheme includes a plurality of distinct non-overlapping clusters corresponding to a partition of the plurality of identities based on a similarity measure of the associated activities;
for at least one distinct non-overlapping cluster of at least one of the plurality of candidate clustering schemes, determining a reduced permission policy, the reduced permission policy excluding at least one permission included in the permission policy for at least one identity included in the cluster, while allowing each identity in the cluster to subsequently perform each associated activity;
calculating an average risk margin for each candidate clustering scheme based on the at least one reduced permission policy for the at least one cluster; and
selecting a specific clustering scheme from the plurality of candidate clustering schemes based on a number of clusters for each candidate clustering scheme and the average risk margin for each candidate clustering scheme.

21-40. (canceled)
